(19) United States
(12) Patent Application Publication
(10) Pub. No.: US 2008/0278285 A1
(43) Pub. Date: Nov. 13, 2008

(54) RECORDING DEVICE

(76) Inventors: Hideki Matsushima, Osaka (JP); Rieko Asai, Osaka (JP); Manabu Maeda, Osaka (JP); Kaoru Yokota, Hyogo (JP)

Correspondence Address: WENDEROTH, LIND & PONACK L.L.P., 2033 K. STREET, NW, SUITE 800, WASHINGTON, DC, 20006, US

(21) Appl. No.: 11/951,051

(22) Filed: Dec. 5, 2007

(30) Foreign Application Priority Data
Dec. 7, 2006 (JP) 2006-330193
Nov. 30, 2007 (JP) 2007-310986

(51) Int. Cl. H04L 9/32

(52) U.S. Cl. 340/5.74

(57) ABSTRACT

When a recording media 10 including secure areas is inserted in an electronic terminal 30, the electronic terminal 30 reads a predetermined program from the recording media 10. As a result of processing performed by the program, the recording media 10 judges a boot state of the electronic terminal 30 when the recording media 10 is inserted in the electronic terminal 30. As a result of the judgment, when the recording media 10 is inserted in the electronic terminal 30 immediately after the electronic terminal 30 is booted, the recording media 10 imposes a loose restriction of accessing the secure areas. As a point of time when the recording media 10 is inserted in the electronic terminal 30 is nearer to a point of time when the boot of the electronic terminal 30 has been completed, the recording media 10 imposes a severer restriction of accessing the secure areas.

This application is based on applications No. 2006-330193 and No. 2007-310986 filed in Japan, the content of which is hereby incorporated by reference.

### BACKGROUND OF THE INVENTION

(1) Field of the Invention

The present invention relates to a technique of verifying validity of an apparatus that accesses a recording device, in order to restrict access from an unauthorized apparatus to data in the recording device, especially to confidential data.

(2) Related Art

A conventional technique of preventing unauthorized use of data has been widely used for properly protecting confidential data such as personal information, a trade secret, or the like.

A thin client system is an example of the above conventional technique. In the thin client system, a server manages resources such as a file, an application, and the like. Also, in the thin client system, a user terminal does not have a function of recording data such as a HDD (Hard Disk Drive) or an optical write drive to prevent a user from taking out data. On the other hand, the user terminal has a minimum function such as a monitor or a keyboard. This can prevent an unauthorized leak of data.

In the thin client system, only a terminal adopted to the thin client system can basically access a server in order to protect data. Therefore, if the terminal adopted to the thin client system is not placed around a user, the user cannot access data. For example, if the user is in a business trip destination, the user cannot use the terminal adopted to the thin client system. Also, a client terminal for the thin client system requires a dedicated hardware structure and a dedicated software structure, and it costs a lot to develop and introduce the client terminal for the thin client system. Therefore, it is practically difficult to place the client terminal for the thin client system anywhere in order to make it convenient to access data.

In addition to the thin client system, as a technique of realizing protection of data, there is a technique of preventing unauthorized access by permitting data exchange only when an apparatus is authorized. In recent years, a TCG (Trusted Computing Group) that is established to develop and promote a secure platform has published a technique of authenticating an apparatus using a security core module called a TPM (Trusted Platform Module). For example, the following technique has been disclosed by U.S. Patent Application Publication No. 2006/0047944 (hereinafter, referred to as “patent document 1”). In the technique, by using the technique of the TCG, a portable recording media authenticates an apparatus when the apparatus is booted, and decrypts encrypted data stored in the portable recording media using a key obtained from a server to use the decrypted data in the apparatus.

In the technique disclosed by the patent document 1, validity of an apparatus is verified by authenticating the apparatus, and data exchange is performed with the valid apparatus. Therefore, as long as the apparatus is valid, if a user has a portable recording media, the user can access data in the portable recording media regardless of a location of the user. That is to say, the user is released from inconvenience caused because the user cannot access a server as in the thin client system, i.e. inconvenience caused because the user might not be able to access data.

However, in the technique disclosed by the patent document 1, it is required that a recording media always boots an apparatus and performs authentication processing to access data in the recording media. In detail, even if the recording media is connected to the apparatus when the apparatus has been booted after boot processing, the data in the recording media cannot be accessed. Also, some pieces of data recorded in the recording media are relatively strongly requested to protect, and other pieces of data are relatively little requested to protect because damage is not so serious even if information of the data is leaked. Note that whether data is relatively strongly requested to protect or relatively little requested to protect is determined by various viewpoints, and may be determined by a subjective viewpoint. For example, information such as personal information or a credit card number is the data that is relatively strongly requested to protect for a large number of people, from a viewpoint of privacy protection and magnitude of monetary value. On the other hand, even if information such as a favorite URL (Uniform Resource Locator) is leaked, damage is not so serious unless an individual can be identified by the favorite URL. In other words, the favorite URL is the data that is relatively little requested to protect.

As a result, in the technique disclosed by the patent document 1, even if a user would like to access the data that is relatively little requested to protect, the user has to reboot an apparatus each time and wait a boot process of an OS (Operating System). Therefore, it is inconvenient for the user.

### SUMMARY OF THE INVENTION

In view of the above problem, an object of the present invention is to provide a recording device that secures confidentiality of data and has high convenience.

To fulfill the above object, the present invention is a recording device that is connectable to an electronic terminal, comprising: a secure area for storing data therein; a terminal state judgment unit operable to, upon connection of the recording device with the electronic terminal, judge activation completion states of a plurality of components of the electronic terminal, the plurality of components being activated in stages when the electronic terminal is booted; and an access control unit operable to restrict an accessible range of the secure area from the electronic terminal, according to a result of the judgment by the terminal state judgment unit.

Because the above-mentioned recording device comprises the terminal state judgment unit, access restrictions each has a different level for the secure area can be imposed according to progress of boot processing of an electronic terminal when the recording device is connected to the electronic terminal.

The following simply describes the different levels of access restrictions.

For example, suppose that it is turned out that the recording device is connected to the electronic terminal when the boot processing of the electronic terminal has been completed, as a result of judgment by the terminal state judgment unit. In this case, the recording device did not authenticate the electronic terminal when the electronic terminal started booting. Therefore, the recording device judges that validity of the electronic terminal is unclear, and imposes a severe restriction on access to the secure area, i.e. limits the accessible range.

On the other hand, suppose that it is turned out that the recording device is connected to the electronic terminal when the electronic terminal started performing the boot processing (or when a power supply of the electronic terminal is ON), as a result of judgment by the terminal state judgment unit. In this case, the recording device itself verifies validity of the electronic terminal when the electronic terminal started booting. Therefore, the electronic terminal can access a large part of the secure area because reliability of the electronic terminal is regarded as relatively high.

With the above-mentioned structure, with regard to the data that is relatively little requested to protect, the electronic terminal can access the recording device regardless of the progress of the boot processing of the electronic terminal, by imposing a loose access restriction. That is to say, it is not required to reboot the electronic terminal each time unlike the technique disclosed by the patent document 1. On the other hand, with regard to the data that is relatively largely requested to protect and is not desired to improperly obtain, the electronic terminal can access the recording device only if the recording device is connected to the electronic terminal from when the boot processing of the electronic terminal starts. As a result, a protection standard of the data can be improved. In other words, the present invention can realize a recording device that has high convenience without sacrificing safety of data to be protected.

Here, the electronic terminal sequentially updates configuration information indicating a configuration of the electronic terminal, in response to activation of each of the plurality of components, and the terminal state judgment unit obtains the configuration information upon the connection of the recording device with the electronic terminal and performs the judgment based on the obtained configuration information.

When the electronic terminal sequentially updates the configuration information as mentioned above, the recording device does not require a particular unit to investigate a structure of the electronic terminal.

Here, the recording device stores therein a terminal control program including a code for controlling the electronic terminal, the terminal control program is read and executed by the electronic terminal upon the connection of the recording device with the electronic terminal, the terminal control program includes an output step of causing the electronic terminal to output the configuration information to the recording device, and the terminal state judgment unit receives, after the terminal control program is executed by the electronic terminal, the configuration information outputted in the output step and performs the judgment based on the received configuration information.

With the above-mentioned structure, the configuration information is outputted to the recording device according to the program transmitted from the recording device. Therefore, reliability of the judgment by the terminal state judgment unit can be improved compared with a case in which the configuration information is outputted from the electronic terminal to the recording device according to a program from an unknown origin.

Here, the recording device stores therein a terminal control program including a code for controlling the electronic terminal, the terminal control program includes specific information, and is read and executed by the electronic terminal upon the connection of the recording device with the electronic terminal, the electronic terminal updates the configuration information every time any of the plurality of components is activated, the terminal control program includes an updating step of causing the electronic terminal to update the configuration information every time any unactivated component of the plurality of components is activated, and in the updating step, the electronic terminal updates the configuration information by processing using information about the unactivated component and the specific information.

With the above-mentioned structure, because the terminal control program updates the configuration information using specific information, a value indicated by the configuration information when a boot of the electronic terminal is completed is different according to a timing at which the recording device is connected to the electronic terminal. Therefore, a boot completion state of each of the plurality of components when the recording device is connected to the electronic terminal can be figured out based on the configuration information when a boot of the electronic terminal is completed.

Here, the recording device holds, as comparative information, a value to be indicated by the configuration information upon completion of activation of all of the plurality of components, the comparative information includes a plurality of values to be indicated by the configuration information that are determined according to which one of the plurality of components is a target of the updating, and the terminal state judgment unit performs the judgment by comparing a value of the obtained configuration information with the plurality of values to be indicated by the configuration information to see which one of the plurality of values is identical to the value of the obtained configuration information.

With the above-mentioned structure, even if a connection between the recording device and the electronic terminal is terminated once, a value indicated by the configuration information is according to a timing at which the recording device is connected to the electronic terminal. Therefore, a boot completion state of each of the plurality of components when the recording device is connected to the electronic terminal for the first time can be figured out, when the recording device is connected to the electronic terminal again. As a result, even if the recording device is connected to the electronic terminal again, an access restriction equivalent to the access restriction when the recording device is connected to the electronic terminal for the first time can be imposed.

More specifically, the electronic terminal performs the updating by initializing the configuration information when the electronic terminal is booted or reset, and adding a value to the configuration information in stages in response to the activation of each of the plurality of components, and the terminal state judgment unit performs the judgment based on whether or not the value is added to the configuration information.

Here, the electronic terminal includes a Trusted Platform Module specified by a Trusted Computing Group, a hash value of each of the plurality of components is transmitted to the Trusted Platform Module in response to the activation of the component, the Trusted Platform Module includes a plurality of PCRs and performs processing of extending a value of each of the plurality of PCRs using the transmitted hash value to store the extended value in the PCR, the configuration information is the extended value stored in the PCR, and the terminal state judgment unit performs the judgment according to whether or not a value other than an initial value is stored in a predetermined PCR of the plurality of PCRs upon the connection of the recording device with the electronic terminal.

Also, the electronic terminal updates the configuration information in stages in response to the activation of each of the plurality of components, and the terminal state judgment unit performs the judgment by comparing a value to be indicated by the configuration information in each of the stages with a value of the obtained configuration information to see which value is identical to the value of the obtained configuration information.

Here, the electronic terminal includes a Trusted Platform Module specified by a Trusted Computing Group, a hash value of each of the plurality of components is transmitted to the Trusted Platform Module in response to the activation of the component, the Trusted Platform Module includes a PCR and performs processing of extending a value of the PCR using the transmitted hash value to store the extended value in the PCR, the configuration information is the extended value stored in the PCR, and the terminal state judgment unit performs the judgment by comparing a value to be stored in the PCR in each of the stages with a value of the PCR upon the connection of the recording device with the electronic terminal to see which value is identical to the value of the PCR.

Also, the secure area is accessible only when the judgment is performed by the terminal state judgment unit, the electronic terminal includes: an input-output interface that detects whether or not the recording device is connected to the electronic terminal; and a receiving unit operable to, when the detection is performed by the input-output interface, receive a user input requesting to (i) perform first boot processing including the judgment by the terminal state judgment unit or (ii) perform second boot processing excluding the judgment, when the receiving unit receives the user input requesting to perform the first boot processing, the electronic terminal performs processing for the judgment by the terminal state judgment unit, and when the receiving unit receives the user input requesting to perform the second boot processing, the electronic terminal prohibits the processing for the judgment by the terminal state judgment unit.

With the above-mentioned structure, when it is required to only access an area other than the secure area, the processing for judging performed by the terminal state judgment unit is not performed. Therefore, it is possible to immediately access the area.

Moreover, the present invention is a recording device that is connectable to an electronic terminal, comprising: a secure area for storing data therein; an obtaining unit operable to, upon connection of the recording device with the electronic terminal, obtain activation state information indicating which one of a plurality of activation states corresponds to activation completion states of a plurality of components of the electronic terminal, the plurality of components being activated in stages when the electronic terminal is booted; and an access control unit operable to restrict an accessible range of the secure area from the electronic terminal, according to the activation state indicated by the obtained activation state information.

With the above-mentioned structure, even if the structure of the recording device is simple, the access restriction to the secure area can be imposed.

Furthermore, the present invention is an integrated circuit used for a recording device that is connectable to an electronic terminal and comprises a secure area for storing data therein, the integrated circuit including: a terminal state judgment unit operable to, upon connection of the recording device with the electronic terminal, judge activation completion states of a plurality of components of the electronic terminal, the plurality of components being activated in stages when the electronic terminal is booted; and an access control unit operable to restrict an accessible range of the secure area from the electronic terminal, according to a result of the judgment by the terminal state judgment unit.

Also, the present invention is an access restriction method of restricting access from an electronic terminal to a recording device that is connectable to the electronic terminal and comprises a secure area for storing data therein, the access restriction method including: a terminal state judgment step of, upon connection of the recording device with the electronic terminal, judging activation completion states of a plurality of components of the electronic terminal, the plurality of components being activated in stages when the electronic terminal is booted; and an access control step of restricting an accessible range of the secure area from the electronic terminal, according to a result of the judgment by the terminal state judgment step.

Moreover, the present invention is a program recording medium that records therein a computer readable control program for causing a recording device to perform processing of restricting access from an electronic terminal to the recording device that is connectable to the electronic terminal and comprises a secure area for storing data therein, wherein the control program includes: a terminal state judgment step of, upon connection of the recording device with the electronic terminal, causing the recording device to perform processing of judging activation completion states of a plurality of components of the electronic terminal, the plurality of components being activated in stages when the electronic terminal is booted; and an access control step of causing the recording device to perform processing of restricting an accessible range of the secure area from the electronic terminal, according to a result of the judgment by the terminal state judgment step.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

### In the Drawings:

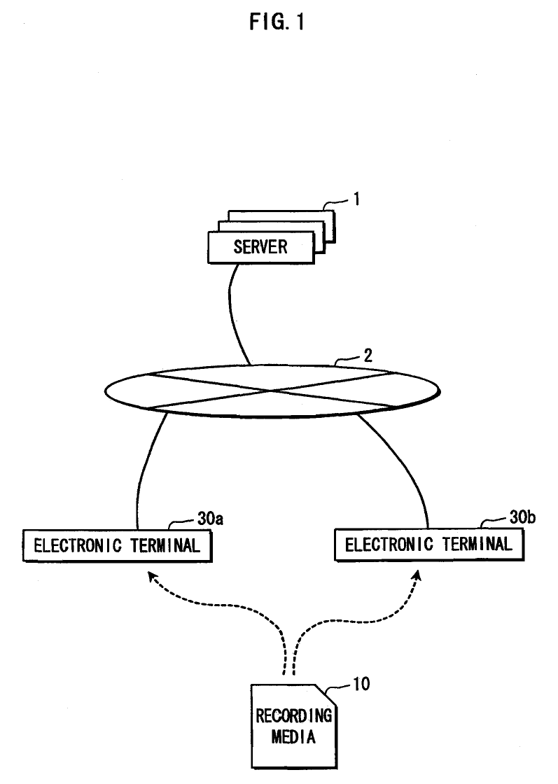

FIG. 1 shows a whole structure of a system of a first embodiment of the present invention;

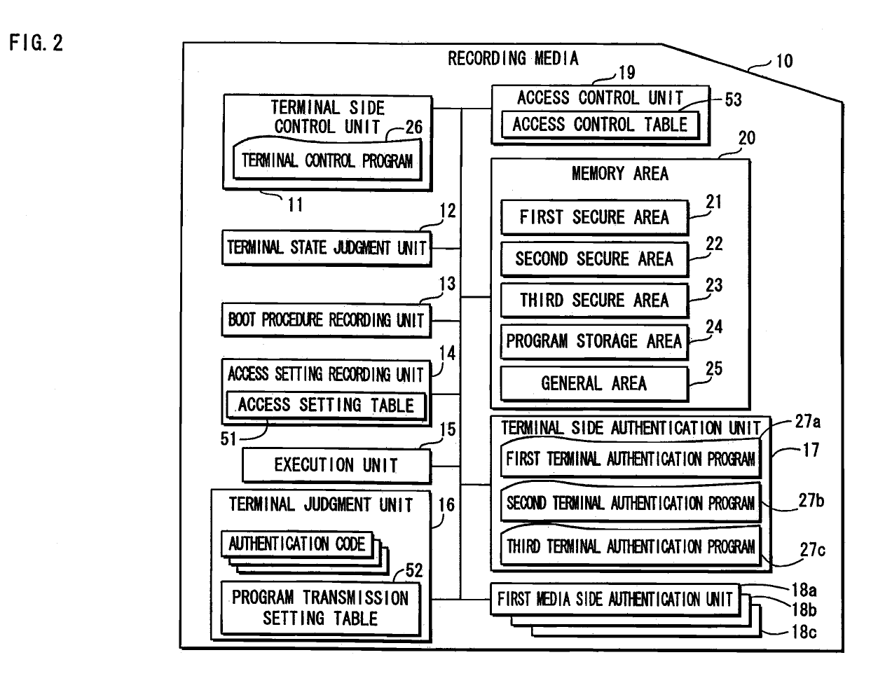

FIG. 2 is a functional block diagram showing a structure of a recording media 10;

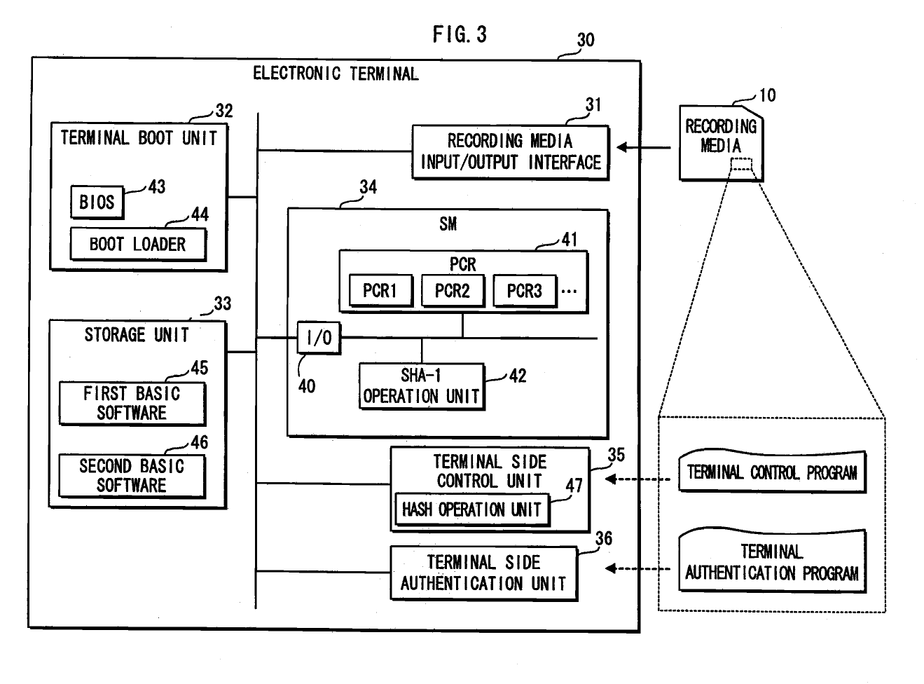

FIG. 3 is a functional block diagram showing a structure of an electronic terminal 30;

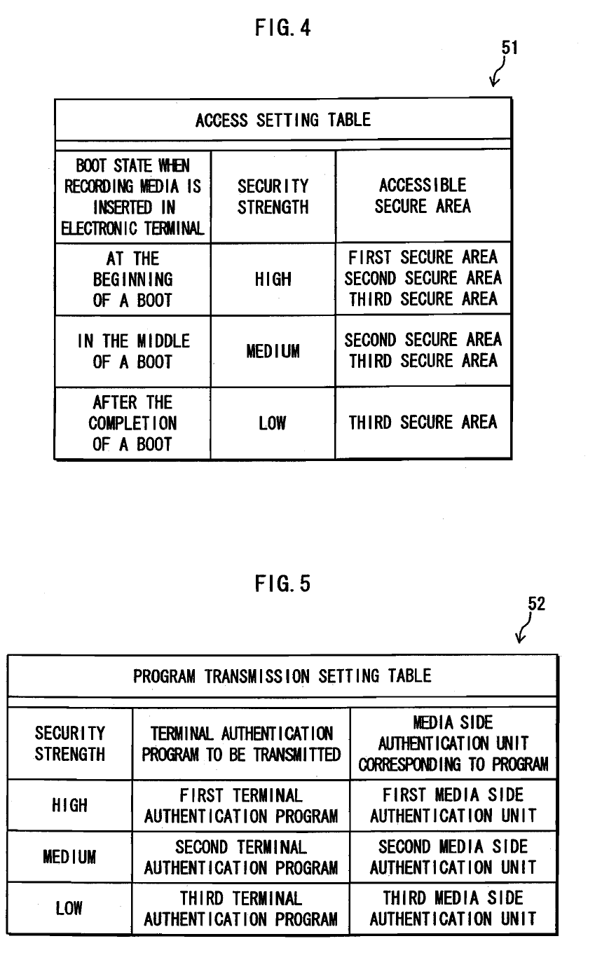

FIG. 4 is a diagram showing an access setting table 51;

FIG. 5 is a diagram showing a program transmission setting table 52;

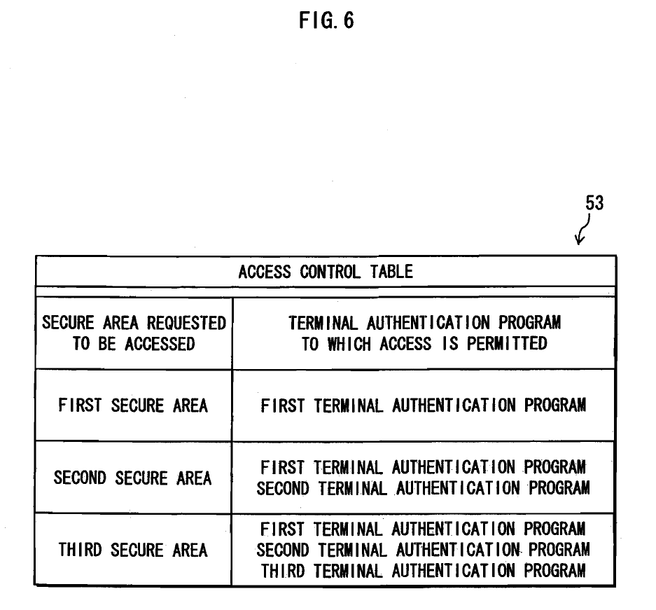

FIG. 6 is a diagram showing an access control table 53;

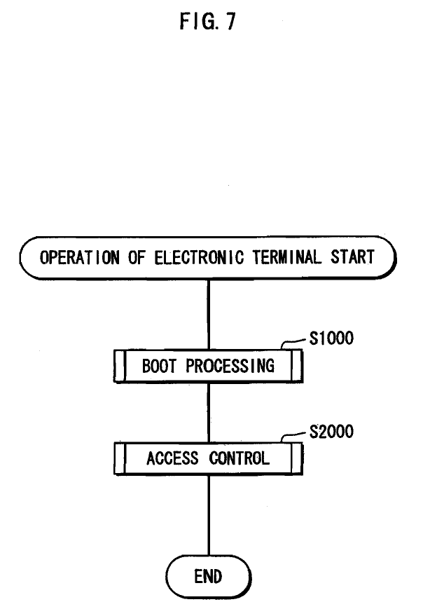

FIG. 7 is a flowchart showing an outline of an operation of the electronic terminal 30;

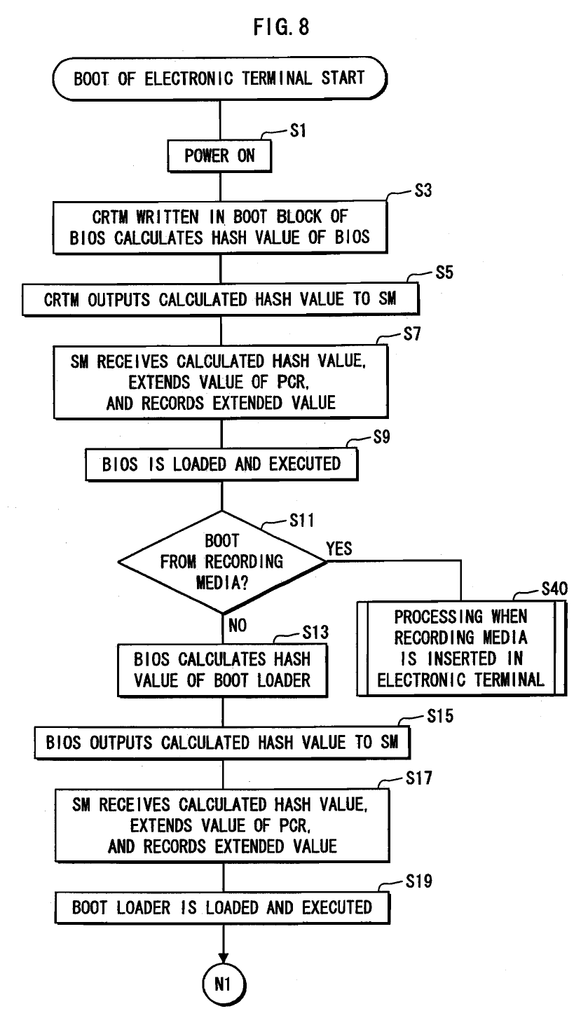

FIG. 8 is a flowchart showing processing from when a boot of the electronic terminal 30 starts to when the boot thereof is completed;

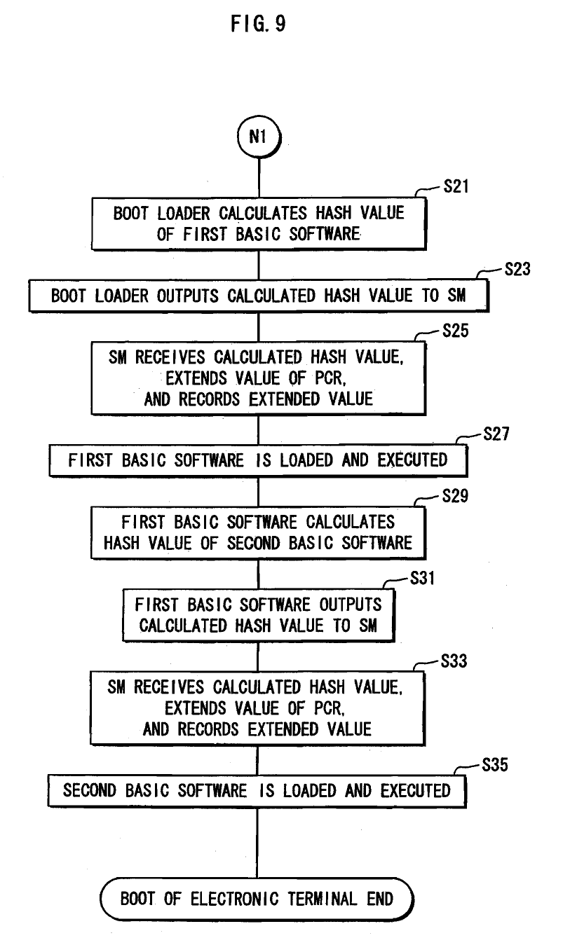

FIG. 9 is a flowchart showing the processing from when the boot of the electronic terminal 30 starts to when the boot thereof is completed;

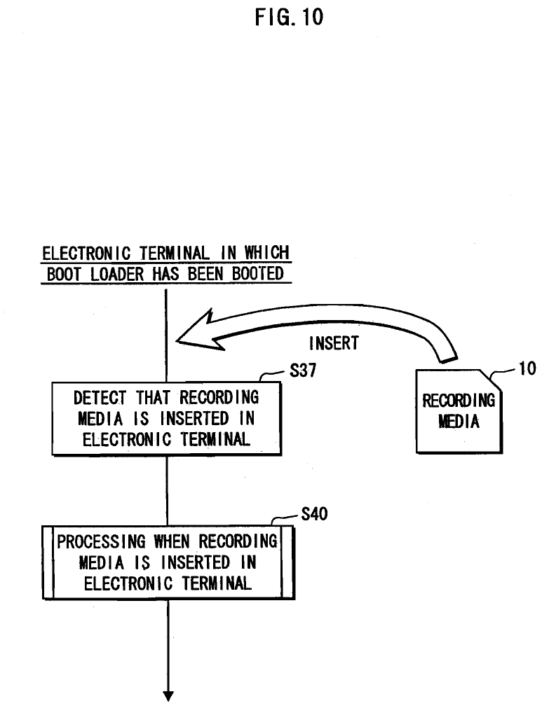

FIG. 10 is a flowchart showing an operation of the electronic terminal 30 when a boot loader has been activated;

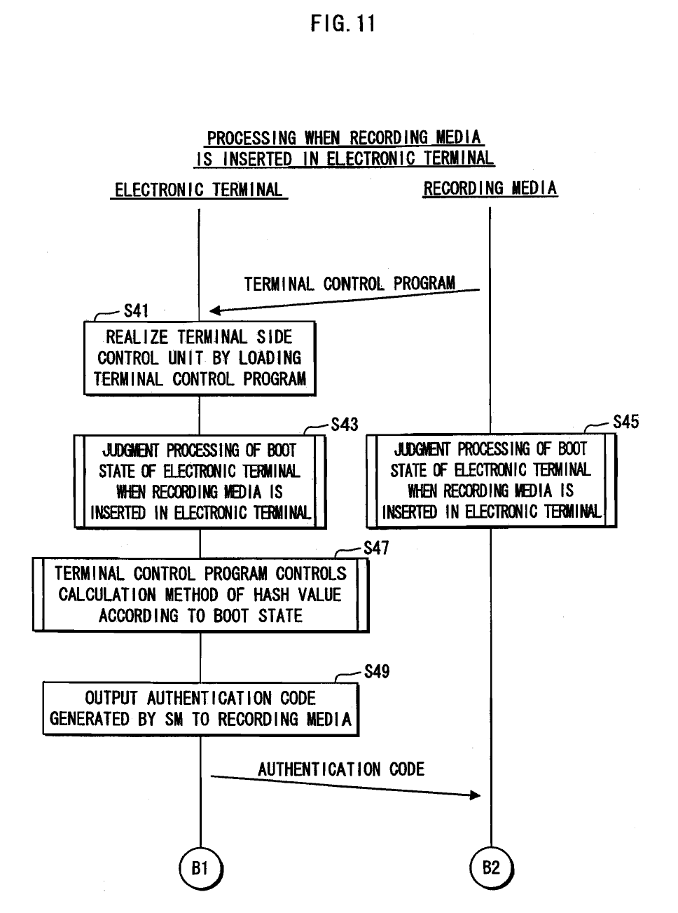

FIG. 11 is a flowchart showing an operation of each of the recording media 10 and the electronic terminal 30 when the recording media 10 is inserted in the electronic terminal 30;

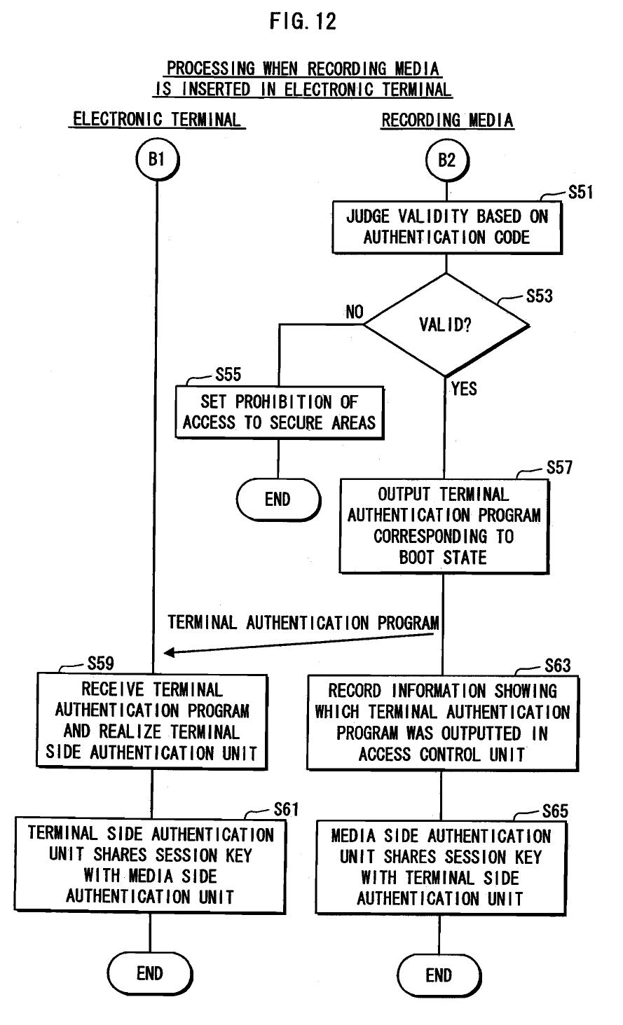

FIG. 12 is a flowchart showing the operation of each of the recording media 10 and the electronic terminal 30 when the recording media 10 is inserted in the electronic terminal 30;

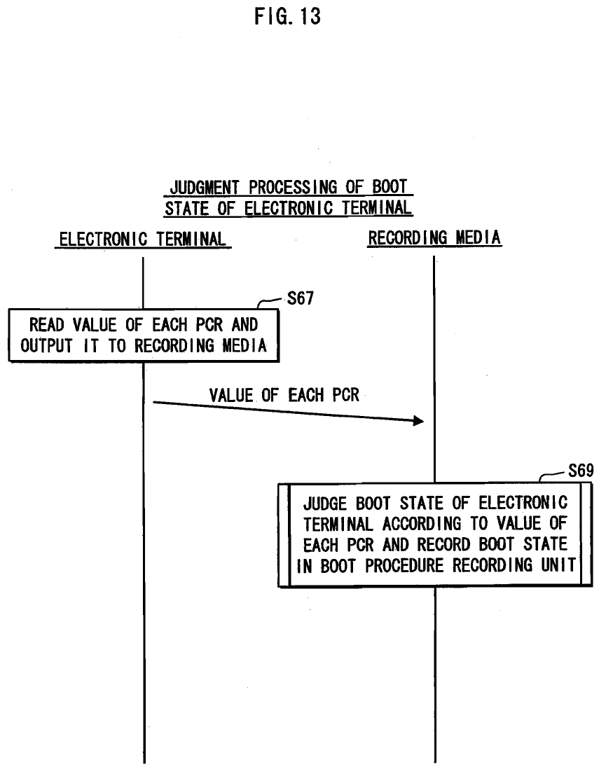

FIG. 13 is a flowchart showing an operation of the electronic terminal 30 and judgment processing of a boot state of the electronic terminal 30, which is performed by a terminal state judgment unit 12;

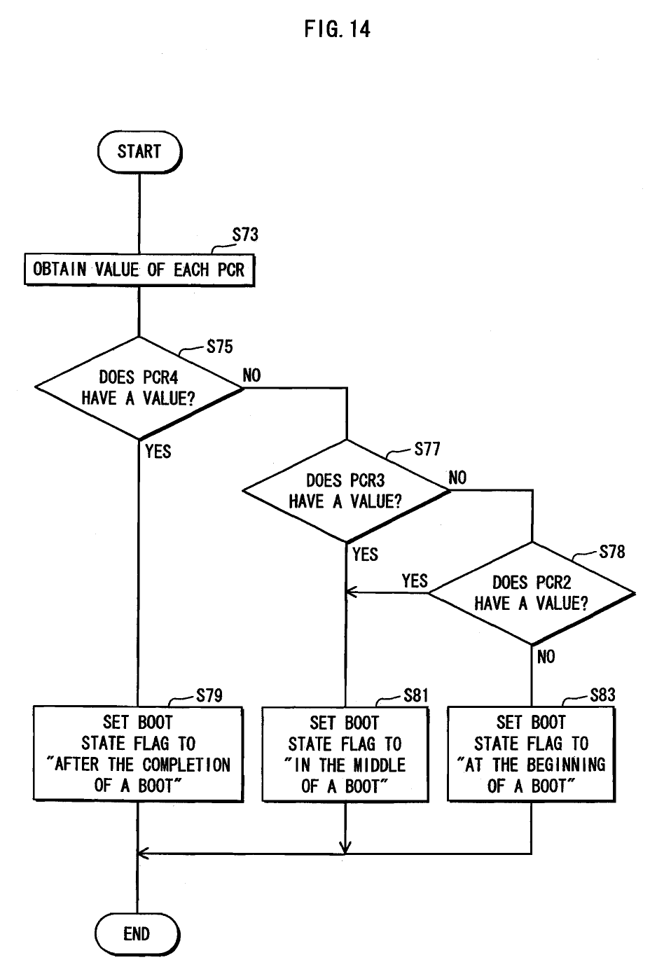

FIG. 14 is a flowchart showing a detail of the judgment processing of the boot state;

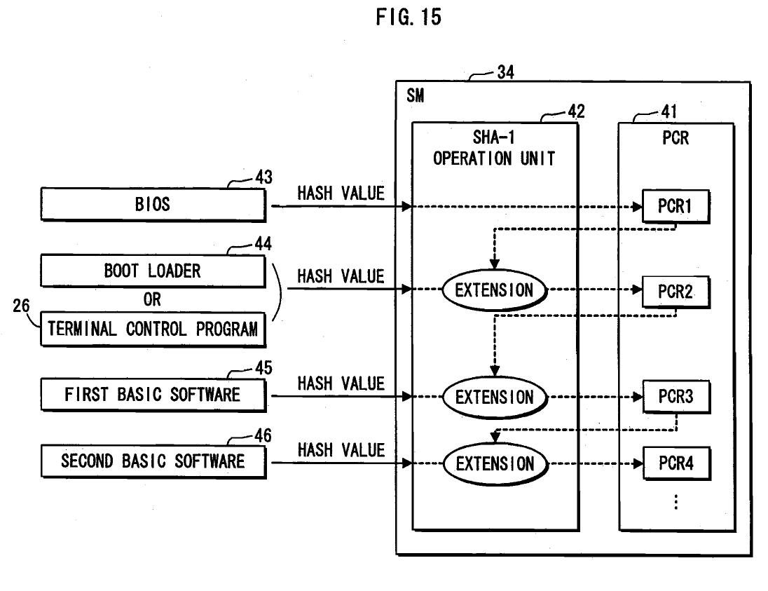

FIG. 15 is a diagram showing a PCR corresponding to each program that is activated when boot processing is performed;

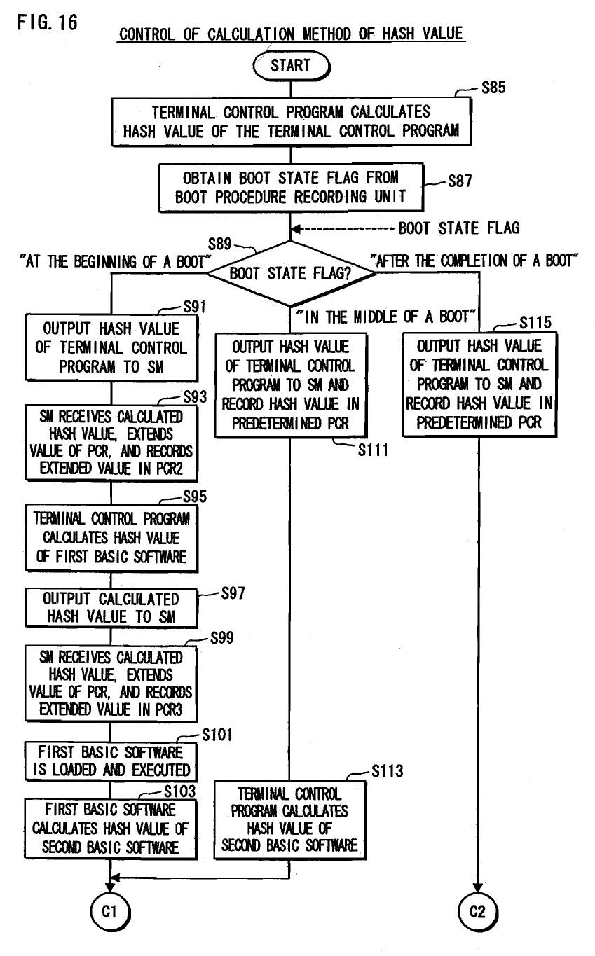

FIG. 16 is a flowchart showing processing of controlling a calculation target of a hash value, which is performed by a terminal control program 26 executed by the electronic terminal 30, after the judgment processing of the boot state is completed;

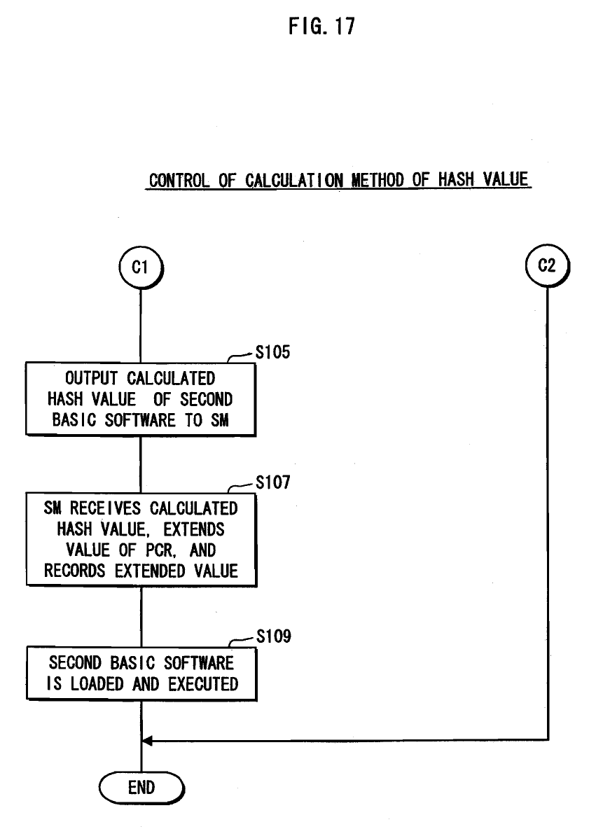

FIG. 17 is a flowchart showing the processing of controlling a calculation target of a hash value, which is performed by the terminal control program 26 executed by the electronic terminal 30, after the judgment processing of the boot state is completed;

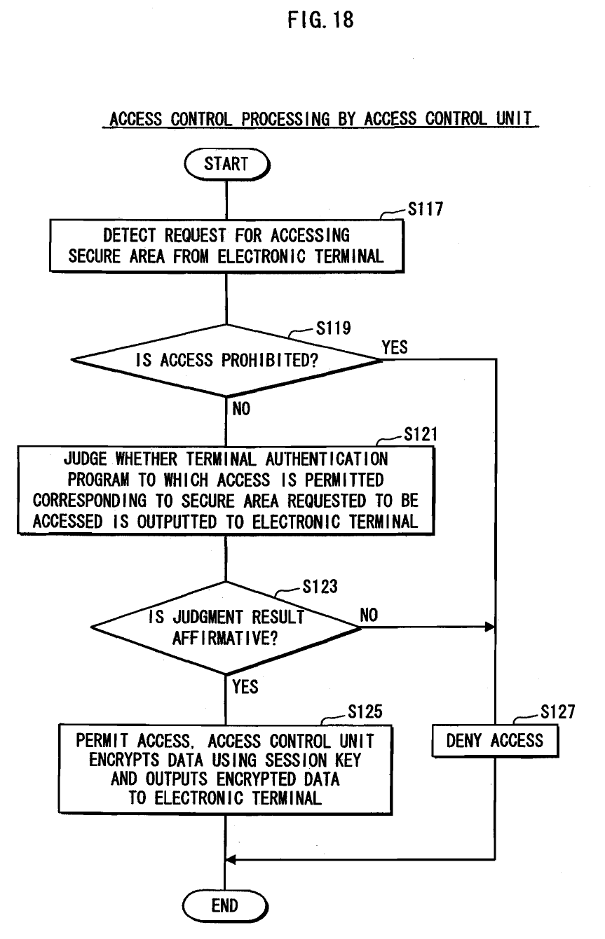

FIG. 18 is a flowchart showing access control processing performed by an access control unit 19;

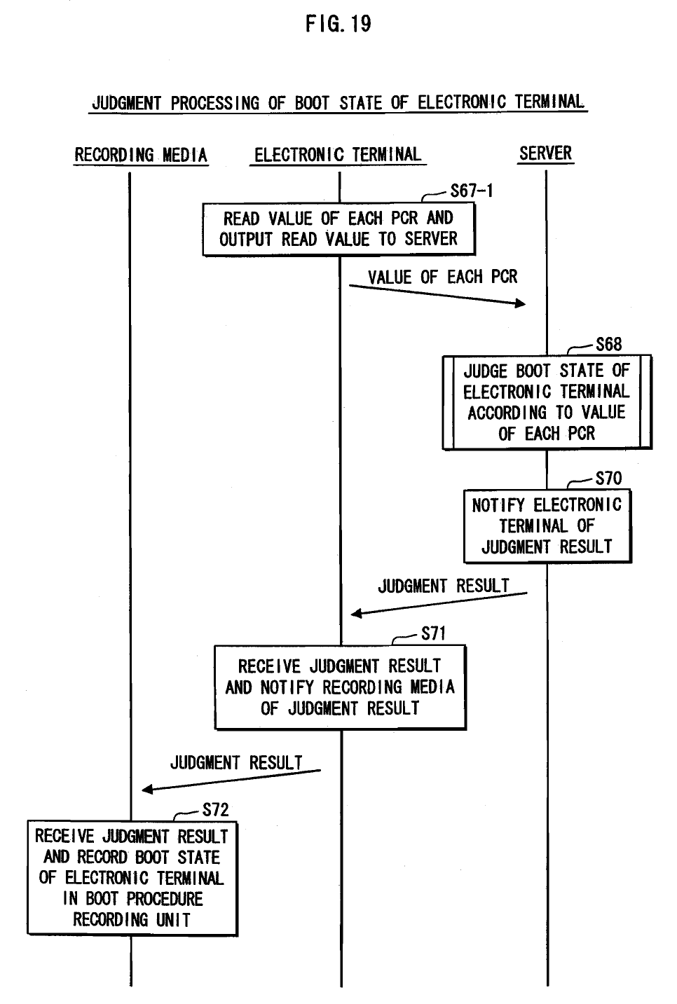

FIG. 19 is a flowchart showing judgment processing of a boot state of the electronic terminal 30, which is performed by an external device;

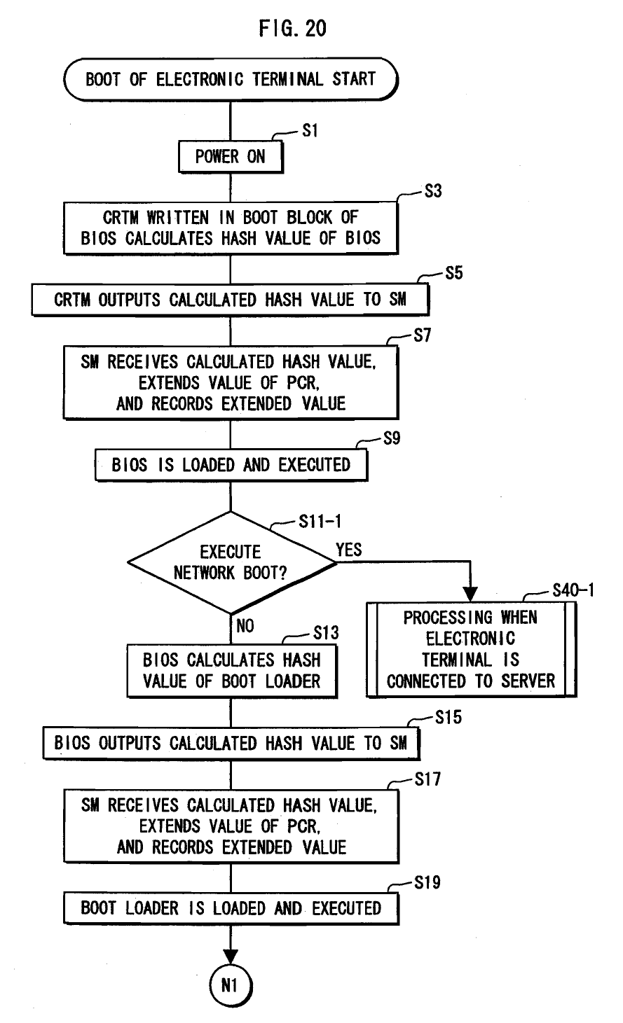

FIG. 20 is a flowchart showing processing performed when the electronic terminal 30 corresponding to a network boot is booted;

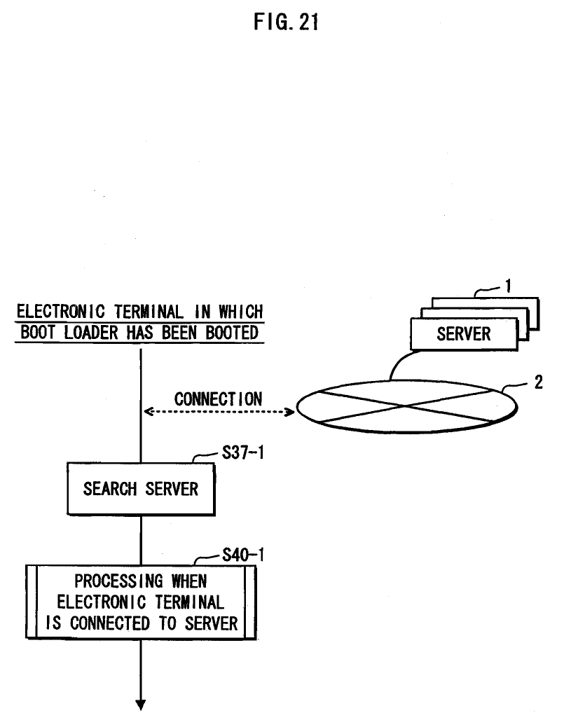

FIG. 21 is a flowchart showing processing performed when the electronic terminal 30 detects a server corresponding to the network boot, when a boot loader 44 of the electronic terminal 30 has been activated;

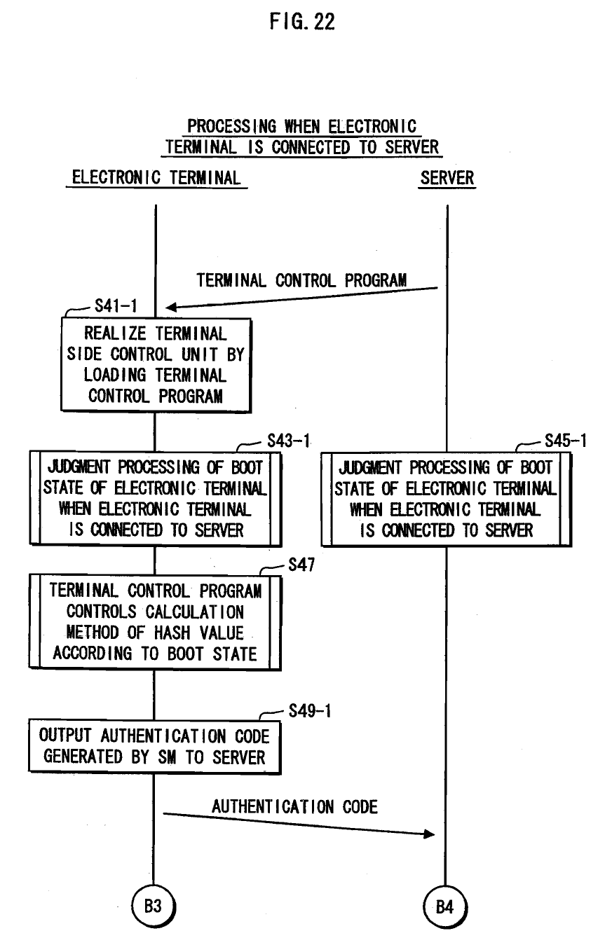

FIG. 22 is a flowchart showing processing performed when the electronic terminal 30 is connected to a server corresponding to the network boot;

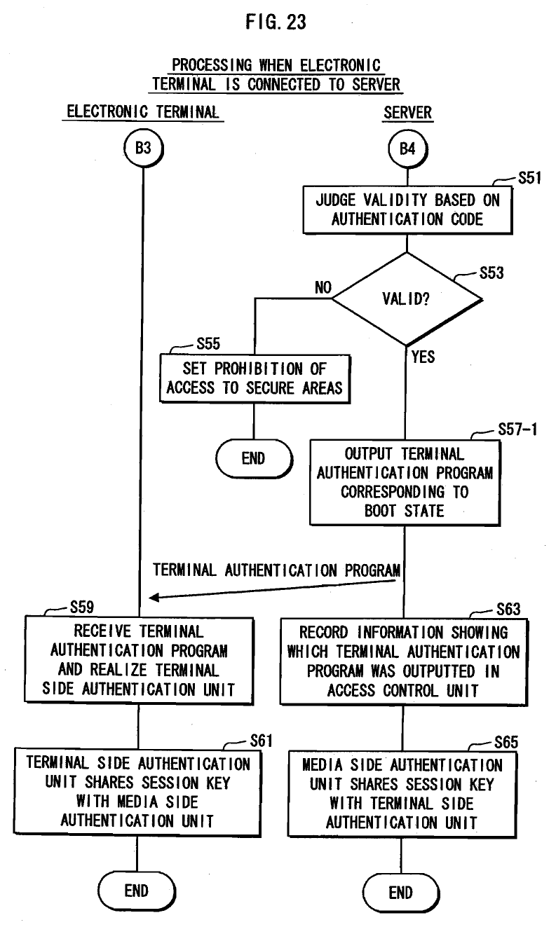

FIG. 23 is a flowchart showing the processing performed when the electronic terminal 30 is connected to the server corresponding to the network boot;

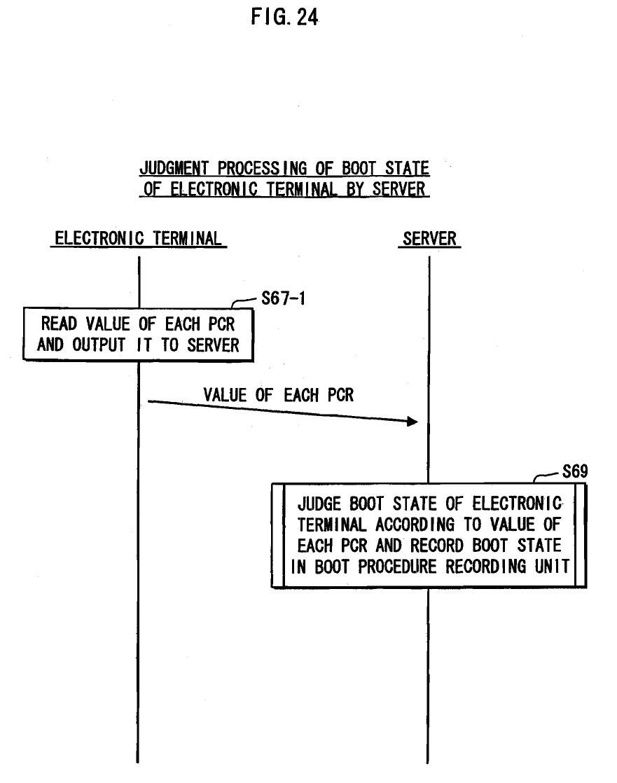

FIG. 24 is a flowchart showing an operation of the electronic terminal 30 and judgment processing of a boot state of the electronic terminal 30 that is performed by a server 1;

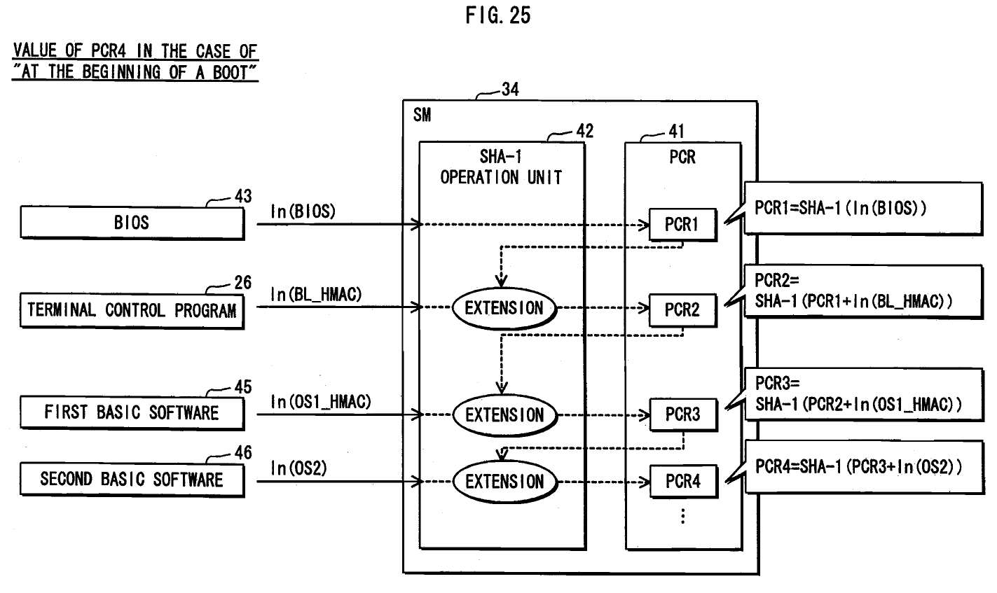

FIG. 25 is a diagram showing a value of a PCR4 in a case of “at the beginning of a boot”;

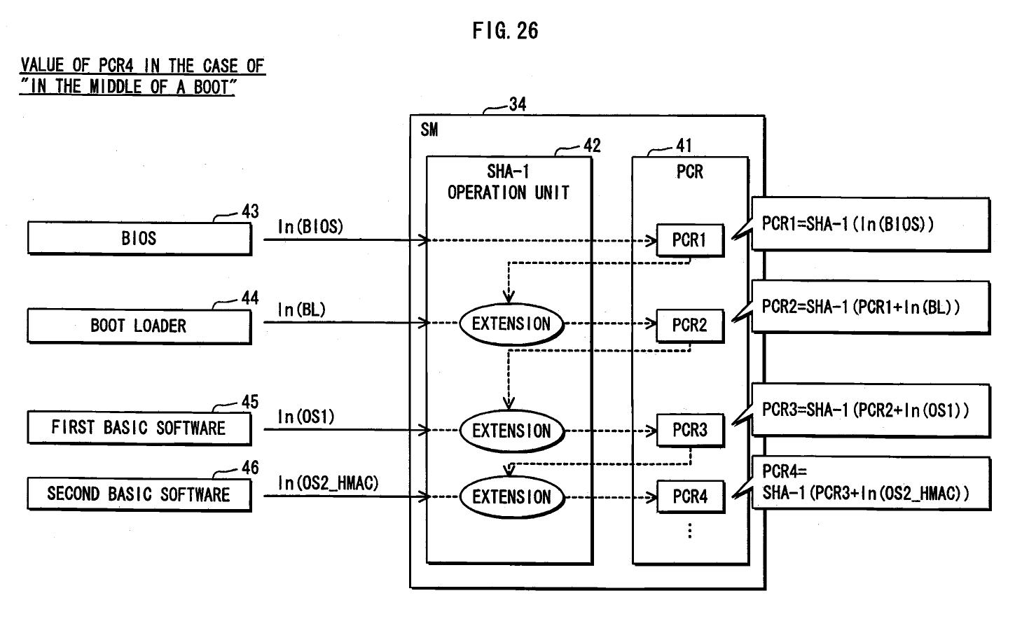

FIG. 26 is a diagram showing a value of the PCR4 in a case of “in the middle of a boot”;

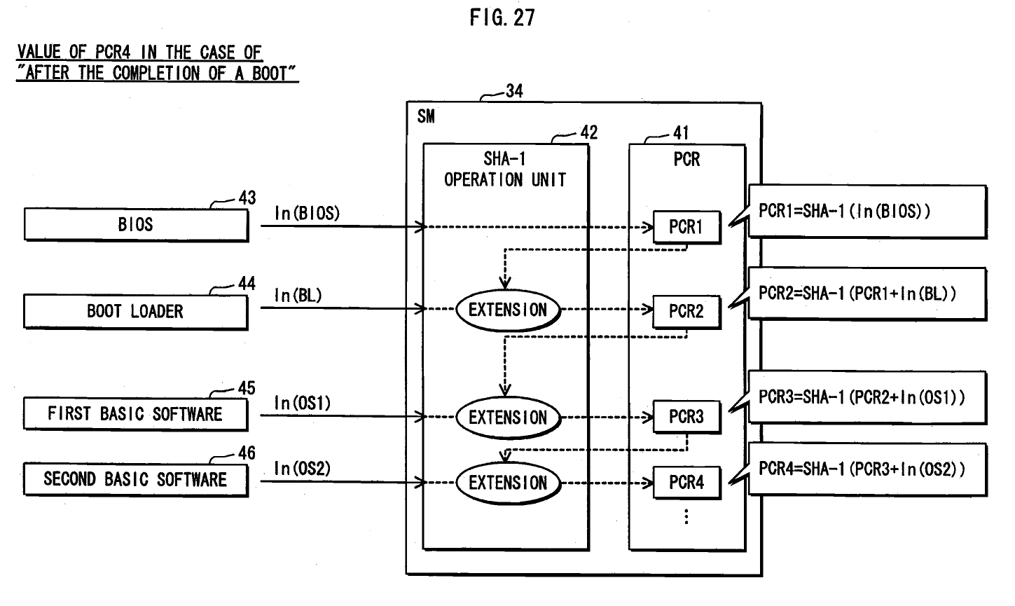

FIG. 27 is a diagram showing a value of the PCR4 in a case of “after the completion of a boot”;

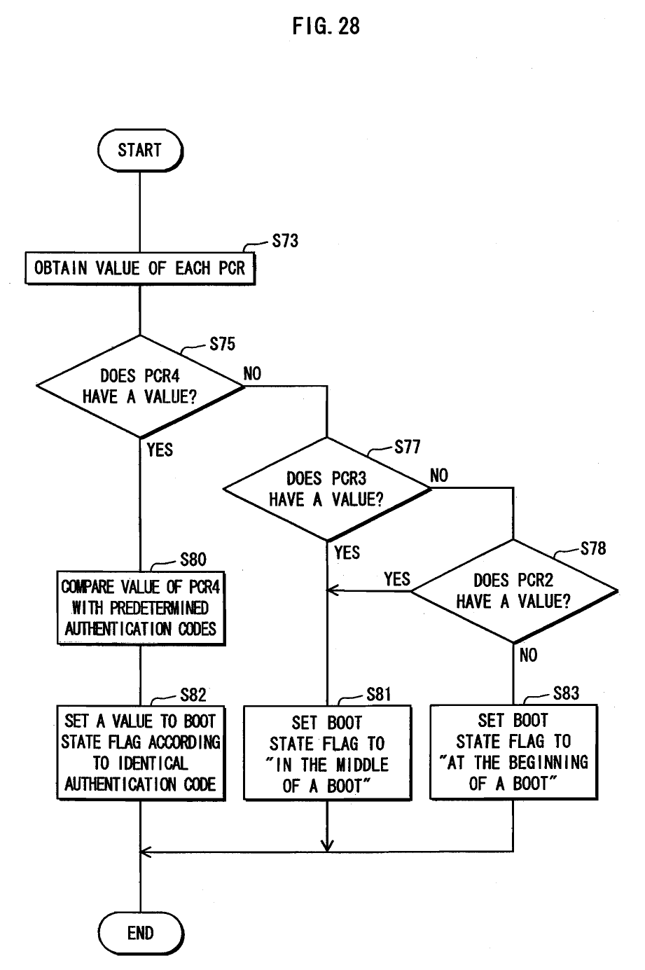

FIG. 28 is a flowchart showing a detail of the judgment processing of the boot state; and

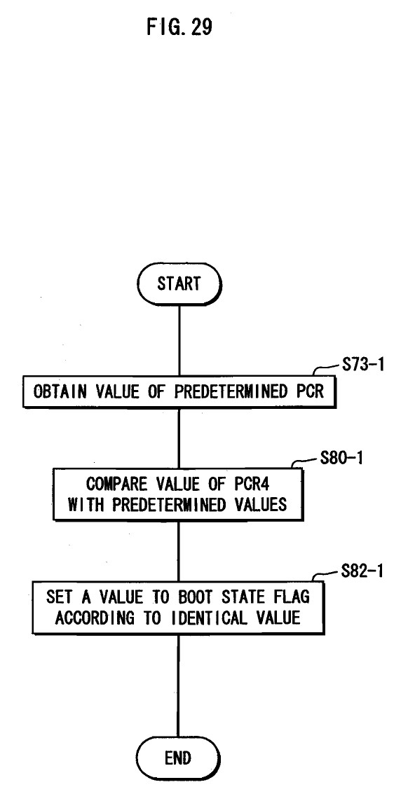

FIG. 29 is a flowchart showing a detail of the judgment processing of the boot state.

### DESCRIPTION OF REFERENCE NUMERALS

1 server
2 network
10 recording media
11 terminal control unit
12 terminal state judgment unit
13 boot procedure recording unit
14 access setting recording unit
15 execution unit
16 terminal judgment unit
17a, 17b, 17c terminal side authentication unit
18a, 18b, 18c media side authentication unit
19 access control unit
20 memory area
21 first secure area
22 second secure area
23 third secure area
24 program storage area
25 general area
(30a, 30b) electronic terminal
31 recording media input-output interface
32 terminal boot unit
33 storage unit
34 SM
35 terminal side control unit
36 terminal side authentication unit
41 PCR
42 SHA-1 operation unit
43 BIOS
44 boot loader
45 first basic software
46 second basic software

### DESCRIPTION OF THE PREFERRED EMBODIMENT

### Embodiment

The following mainly describes a recording device of the present invention, with reference to the attached drawings.

### 1. Outline

FIG. 1 shows a whole structure of a system of an embodiment of the present invention.

As shown in FIG. 1, a server is connected to an electronic terminals 30a and 30b via Internet 2. Note that the electronic terminals 30a and 30b can perform boot processing using a recording media 10 (hereinafter, referred to also as “recording device”), and each of the electronic terminals 30a and 30b is not required to have a same structure if having a function of putting the present invention into practice. Therefore, hereinafter, the electronic terminals 30a and 30b will be described as an electronic terminal 30 without distinguishing the electronic terminals 30a and 30b. Also, it is not necessary that the number of the electronic terminal 30 is plural (two electronic terminals 30a and 30b in FIG. 1), and the number of the electronic terminal 30 may be one.

The server 1 communicates with the electronic terminal 30 to provide services such as a browse of information through a website, an online store that sells goods such as a book and a CD, and delivery of contents such as music data and image data.

The recording media 10 is realized by a portable recording media such as a SD card.

The electronic terminal 30 is realized as a PC (Personal Computer) terminal that is placed in a public place such as a station or an airport, and a mobile terminal that can be taken out to an outside location. Also, the electronic terminal 30 is realized as, for example, a terminal that has a function equivalent to a function of a terminal that is routinely used by a user of the recording media 10, such as a mobile terminal that has a function equivalent to a function of a PC terminal that is placed in an office in a company. The electronic terminal 30 is a computer system including a CPU (Central Processing Unit), a RAM (Random Access Memory), and the like, which will be specifically described later. The recording media 10 can be inserted in the electronic terminal 30.

### 2. Structure

The following describes a structure of each of the recording media 10 and the electronic terminal 30.

### 2.1. Structure of the Recording Media 10

The following describes a structure of the recording media 10 in detail.

FIG. 2 is a functional block diagram showing the structure of the recording media 10. The recording media 10 includes a terminal side control unit 11, a terminal state judgment unit 12, a boot procedure recording unit 13, an access setting recording unit 14, an execution unit 15, a terminal judgment unit 16, a terminal side authentication unit 17, a first media side authentication unit 18a, a second media side authentication unit 18b, a third media side authentication unit 18c, an access control unit 19, and a memory area 20.

### 2.1.1. Terminal Side Control Unit 11

The above components will be described in the stated order. As shown in FIG. 2, the terminal side control unit 11 stores a terminal control program 26.

The terminal control program 26 is read by the electronic terminal 30 and performs various processing when the recording media 10 is inserted in the electronic terminal 30. The terminal control program 26 includes a boot code for booting an OS (Operating System) of the electronic terminal 30. Here, the various processing performed by the terminal control program 26 are such as processing of controlling a boot of the electronic terminal 30, authentication processing of the electronic terminal 30, and the like. Note that the terminal control program 26 holds a key specific to the recording media 10. By using this key and a one-way function, the terminal control program 26 calculates a hash value of the terminal control program 26 itself, a first basic software 45, a second basic software 46 of the electronic terminal 30, or the like. Here, the one-way function used by the terminal control program 26 is a HMAC (Keyed-Hashing for Message Authentication) algorithm in which a key value is used for a one-way function such as SHA-1 or MD5. Therefore, if keys are different, hash values calculated by the terminal control program 26 are different, even if calculation targets of the hash values are same. The above processing performed when the terminal control program 26 is read by the electronic terminal 30 will be specifically described later in an explanation of an operation of the electronic terminal 30.

### 2.1.2. Terminal State Judgment Unit 12

The terminal state judgment unit 12 judges that the electronic terminal 30 is in which state out of a plurality of states that are classified in stages according to progress of activation of software necessary for a completion of a boot of the electronic terminal 30.

More specifically, in this embodiment, the terminal state judgment unit 12 judges that the electronic terminal 30 is in which state (a boot state) out of three states mentioned below. The three states are (i) “at the beginning of a boot”: a state in which neither the first basic software 45 nor the second basic software 46 is activated, (ii) “in the middle of a boot”: a state in which the second basic software 46 is not activated, the first basic software 45 is booted and loaded in a memory, and (iii) “after the completion of a boot”: a state in which the second basic software 46 is booted and loaded in a memory. In other words, a boot state of the electronic terminal 30 is classified into the three states “at the beginning of a boot”, “in the middle of a boot”, and “after the completion of a boot” in this embodiment.

Note that the electronic terminal 30 activates the first basic software 45, and then activates the second basic software 46 in this embodiment, which will be described later. Also, when the second basic software 46 is loaded in the memory and executed, a boot of the electronic terminal 30 is completed in this embodiment. When the boot of the electronic terminal 30 is completed, various application software can be executed in the electronic terminal 30.

The judgment processing of the boot state of the electronic terminal 30 is performed by the terminal state judgment unit 12 when the recording media 10 is inserted in the electronic terminal 30. A detailed explanation of this judgment processing will be described later together with an operation of the electronic terminal 30.

### 2.1.3. Boot Procedure Recording Unit 13

The boot procedure recording unit 13 holds a result of the judgment performed by the terminal state judgment unit 12. For example, the boot procedure recording unit 13 receives the result of the judgment performed by the terminal state judgment unit 12, and stores a boot state flag (boot state information) indicating the result of the judgment. The boot state flag stores, for example, a numerical value. When the boot state flag is “1”, the boot state flag indicates that the result of the judgment is “at the beginning of a boot”. In the same manner as this, when the boot state flag is “2”, the boot state flag indicates that the result of the judgment is “in the middle of a boot”. When the boot state flag is “3”, the boot state flag indicates that the result of the judgment is “after the completion of a boot”.

### 2.1.4. Access Setting Recording Unit 14

The access setting recording unit 14 stores an access setting table 51. In the access setting table 51, whether or not the electronic terminal 30 is permitted to access each of a first secure area 21, a second secure area 22, and a third secure area 23 in the memory area 20 corresponds to each of the boot states of the electronic terminal 30 when the recording media 10 is inserted therein. A detail of the access setting table 51 will be described later.

Note that in this embodiment, whether or not the electronic terminal 30 can access each of the first secure area 21, the second secure area 22, and the third secure area 23 in the memory area 20, which corresponds to each of the boot states of the electronic terminal 30 can be customized by a user. A customize method thereof will be described later.

### 2.1.5. Execution Unit 15

The execution unit 15 executes various processing performed by the recording media 10, such as a request for accessing the memory area 20, data exchange with the electronic terminal 30, and the like.

### 2.1.6. Terminal Judgment Unit 16

The terminal judgment unit 16 judges whether or not the electronic terminal 30 is valid. Also, the terminal judgment unit 16 judges whether or not the terminal control program 26 outputted from the recording media 10 to the electronic terminal 30 is valid.

As shown in FIG. 2, the terminal judgment unit 16 stores a plurality of authentication codes. In this embodiment, if the electronic terminal 30 is judged to be valid when the electronic terminal 30 is verified, a value of any of the plurality of authentication codes is same as a value of an authentication code transmitted from the electronic terminal 30. Note that the terminal judgment unit 16 stores an authentication code having a same value as a value of an authentication code generated by the electronic terminal 30 using a hash value of the first basic software 45 or the like calculated by the terminal control program 26. Also, the terminal judgment unit 16 stores a hash value of the terminal control program 26 when the terminal control program 26 is valid.

The terminal judgment unit 16 judges that the electronic terminal 30 is valid when a value of an authentication code transmitted from the electronic terminal 30 is identical to a value of an authentication code stored in the terminal judgment unit 16. The terminal judgment unit 16 judges that the electronic terminal 30 is not valid when both of the two values are not identical to each other. When a hash value of the terminal control program 26 is transmitted from the electronic terminal 30, the terminal judgment unit 16 compares the hash value with a hash value of the valid terminal control program 26 stored in the terminal judgment unit 16. The terminal judgment unit 16 judges that the terminal control program 26 is valid when both of the two hash values are identical to each other, and judges that the terminal control program 26 is not valid when both of the two hash values are not identical to each other.

When the electronic terminal 30 is judged to be valid, or both the electronic terminal 30 and the terminal control program 26 are judged to be valid, the terminal judgment unit 16 performs the following operation in order to perform communication of data stored in the secure areas (the first secure area 21, the second secure area 22, and the third secure area 23) with the electronic terminal 30. That is to say, the terminal judgment unit 16 specifies one of a plurality of terminal authentication programs stored in the terminal side authentication unit 17 (a first terminal authentication program 27a, a second terminal authentication program 27b, and a third terminal authentication program 27c are shown in FIG. 2) which should be outputted to the electronic terminal 30, by referring to a program transmission setting table 52 and the like (which will be described later). At this time, the terminal judgment unit 16 also specifies a media side authentication unit corresponding to the specified terminal authentication program. In FIG. 2, the first media side authentication unit 18a, the second media side authentication unit 18b, and the third media side authentication unit 18c are shown, and one of the three media side authentication units is specified.

Note that the terminal authentication program and the media side authentication unit will be described later. Also, hereinafter, the first media side authentication unit 18a, the second media side authentication unit 18b, and the third media side authentication unit 18c are gathered together and referred to as a media side authentication unit 18.

### 2.1.7 Terminal Side Authentication Unit 17

The terminal side authentication unit 17 stores the plurality of terminal authentication programs executed by the electronic terminal 30.

The following simply describes each of the plurality of terminal authentication programs. The terminal authentication program is for safe data exchange between the recording media 10 and the electronic terminal 30. When a result of the judgment by the terminal judgment unit 16 is valid, a terminal authentication program specified by the terminal judgment unit 16 is outputted to the electronic terminal 30 by the execution unit 15. Then, the terminal authentication program is executed in the electronic terminal 30. The executed terminal authentication program performs processing of generating a session key by performing authentication processing with a media side authentication unit specified by the terminal judgment unit 16 (one of the first media side authentication unit 18a, the second media side authentication unit 18b, and the third media side authentication unit 18c in this embodiment). Also, the executed terminal authentication program performs processing of safely exchanging data between the recording media 10 and the electronic terminal 30 using the generated session key.

Note that in this embodiment, a plurality of terminal authentication programs are prepared according to a plurality of predetermined levels of security strengths.

### 2.1.8. Media Side Authentication Unit 18

The media side authentication unit 18 performs authentication processing with the terminal authentication program executed in the electronic terminal 30 to perform the processing of generating the session key and the processing of safely exchanging data between the recording media 10 and the electronic terminal 30 using the generated session key as mentioned above. The authentication processing is realized by, for example, a challenge-response type authentication method.

Note that the authentication method is not limited to the challenge-response type. For example, a technique of safely exchanging data by performing authentication processing between two apparatuses and encrypting data has been conventionally known, and the authentication processing may be performed by the above method.

### 2.1.9. Access Control Unit 19

The access control unit 19 restricts an accessible range in the secure areas from the electronic terminal 30, according to a result of the judgment performed by the terminal state judgment unit 12.

More specifically, the access control unit 19 stores an access control table 53 in which each of the first secure area 21, the second secure area 22, and the third secure area 23 corresponds to an accessible terminal authentication program. Also, the access control unit 19 stores which one of the plurality of terminal authentication programs is outputted to the electronic terminal 30 after the judgment performed by the terminal judgment unit 16, or a setting of prohibiting access. The access control unit 19 restricts access from the electronic terminal 30 to the secure areas by performing an operation (which will be described later) using the above stored information.

### 2.1.10. Memory Area 20

The memory area 20 stores data. As shown in FIG. 2, the memory area 20 includes the secure areas (the first secure area 21, the second secure area 22, and the third secure area 23), a program storage area 24, and a general area 25.

In the secure areas, confidential data is generally stored (However, data that is not confidential may be stored). In this embodiment, data in the secure areas is encrypted in order to being safely exchanged. More specifically, the encryption is performed by a media side authentication unit specified by the terminal judgment unit 16 and a terminal authentication program that is specified and outputted to the electronic terminal 30.

Also, access to the data in the secure areas is restricted. In this embodiment, on the first secure area 21 in the secure areas, the severest access restriction is imposed to protect data. On the second secure area 22, the second severest access restriction is imposed, and on the third secure area 23, an access restriction that is looser than the severest access restriction and the second severest access restriction is imposed. For example, data that will suffer serious damage if being illegally obtained or leaked is stored in the first secure area 21. On the other hand, data that will suffer relatively minor damage even if being illegally obtained is stored in the third secure area 23. The following is an example of the access restriction. When placing an emphasis on prevention of monetary damage and protection of personal information, information of a balance of an electronic money, information of a credit card, a name and an address of a holder of the recording media 10 are stored in the first secure area 21 and the second secure area 22. On the other hand, information that is less likely to cause monetary damage or identify an individual even if being illegally obtained, such as a favorite URL is stored in the third secure area 23.

In this embodiment, if the terminal state judgment unit 12 judges that a boot state of the electronic terminal 30 is “at the beginning of a boot” when the recording media 10 is inserted in the electronic terminal 30, access to the first secure area 21, the second secure area 22, and the third secure area 23 is permitted. If a boot state of the electronic terminal 30 is judged to be “in the middle of a boot”, access to the first secure area 21 is not permitted and access to the second secure area 22 and the third secure area 23 is permitted. If a boot state of the electronic terminal 30 is judged to be “after the completion of a boot”, access to the first secure area 21 and the second secure area 22 is not permitted and access to the third secure area 23 is permitted. That is to say, as a point of time when the recording media 10 is inserted in the electronic terminal 30 is nearer to a point of time when the electronic terminal 30 starts booting, the access restriction to the secure areas becomes looser.

This is because of the following reason.

Firstly, the terminal control program 26 recoded in the recording media 10 performs processing of detecting tampering of predetermined software (the first basic software 45 and the second basic software 46 that will be described later) that relates to the boot processing of the electronic terminal 30 as mentioned later. Since the electronic terminal 30 might be an invalid terminal, it would appear that reliability of detecting tampering of the predetermined software is higher when the terminal control program 26 performs the detecting processing than when the electronic terminal 30 performs the detecting processing.

As a point of time when the recording media 10 is inserted in the electronic terminal 30 is nearer to a point of time when the electronic terminal 30 starts booting (i.e. a large part of the predetermined software that relates to the boot processing has not been booted), a possibility that unauthorized software starts activation before the processing performed by the terminal control program 26 becomes smaller, compared with a case in which the recording media 10 is inserted in the electronic terminal 30 when a large part of the predetermined software has been activated in the electronic terminal 30 or a boot of the electronic terminal 30 has been completed. Therefore, it would appear that a possibility that the terminal control program 26 completely detects tampering of the predetermined software that relates to the boot processing of the electronic terminal 30 becomes higher. In other words, if the electronic terminal 30 is booted using the recording media 10 from when the electronic terminal 30 starts booting, the reliability of verifying the validity of the electronic terminal 30 is higher.

As mentioned above, the secure areas include the first secure area 21, the second secure area 22, and the third secure area 23. However, the number of the secure areas is not limited to three.

As mentioned above, when the reliability of verifying the validity is high, it is permitted to access the areas including the area that is permitted to access when the reliability is lower. In the present invention, an independent secure area may be assigned to each reliability level as an accessible area. For example, when a boot state of the electronic terminal 30 is judged to be “at the beginning of a boot”, only access to the first secure area 21 is permitted. When a boot state of the electronic terminal 30 is judged to be “in the middle of a boot”, only access to the second secure area 22 is permitted. When a boot state of the electronic terminal 30 is judged to be “after the completion of a boot”, only access to the third secure area 23 is permitted.

The program storage area 24 is an area for storing a program. In the program storage area 24, an access setting program or the like for updating the access setting table 51 is recorded.

The general area 25 is an area for mainly recording data that is not required to be safely dealt with.

### 2.2 Structure of the Electronic Terminal 30

The following specifically describes the structure of the electronic terminal 30.

FIG. 3 is a functional block diagram showing the structure of the electronic terminal 30. The electronic terminal 30 includes a recording media input-output interface 31, a terminal boot unit 32, a storage unit 33, and a SM (Secure Module) 34. Since the electronic terminal 30 reads the terminal control program 26 from the recording media 10 and loads the terminal control program 26 in a memory to be executed, a terminal side control unit 35 is realized. In the same manner as this, since the electronic terminal 30 reads the terminal authentication program from the recording media 10 and loads the terminal authentication program in a memory to be executed, a terminal side authentication unit 36 is realized.

In this embodiment, the electronic terminal 30 includes a TPM (Trusted Platform Module) whose specification is published by a Trusted Computing Group (TCG) (the SM 34 has a function of the TPM in this embodiment), and can perform processing such as “Integrity Measurement”, “Integrity Reporting”, and “Integrity logging” provided by the TCG. Note that a detail of the TCG can be obtained by referring to a website of the TCG http://www.trustedcomputinggroup.org.

### 2.2.1. Recording Media Input-Output Interface 31

The above components will be described in the stated order. The recording media input-output interface 31 is an interface for the electronic terminal 30 to communicate with the recording media 10. Also, the recording media input-output interface 31 detects that the recording media 10 is inserted in the electronic terminal 30.

### 2.2.2 Terminal Boot Unit 32

The terminal boot unit 32 boots the electronic terminal 30. More specifically, as shown in FIG. 3, the terminal boot unit 32 stores a BIOS 43 and a boot loader 44. The boot loader 44 is a boot program for activating the first basic software 45 that is a part of an OS. Note that the BIOS 43 includes a CRTM (Core Root of Trust Measurement) for calculating a hash value of the boot loader 44, in conformity with the specification of the TCG. Also, the boot loader 44 includes a RTM (Root of Trust Measurement) for calculating a hash value of the first basic software 45, and the first basic software 45 includes the RTM for calculating a hash value of the second basic software 46.

Note that in this embodiment, when the BIOS 43 is activated in the electronic terminal 30, the BIOS 43 detects a boot program for activating the first basic software 45 and reads a boot program from the recording media 10 or the electronic terminal 30. The BIOS 43 puts the reading of the boot program from the recording media 10 ahead of the reading of the boot program from the electronic terminal 30. In detail, when the BIOS 43 detects the boot program, (i) if the recording media input-output interface 31 detects that the recording media 10 is inserted in the electronic terminal 30, the BIOS 43 reads the terminal control program 26 from the recording media 10. The terminal control program 26 includes a boot code for activating the first basic software 45. The first basic software 45 is activated by the terminal control program 26. On the other hand, (ii) if the recording media input-output interface 31 does not detect that the recording media 10 is inserted in the electronic terminal 30, the BIOS 43 performs activation processing of the boot loader 44.

In this embodiment, the BIOS 43 and the boot loader 44 are stored in a secure storage area that has a mechanism of preventing unauthorized access. However, an area in which the BIOS 43 and the boot loader 44 are stored is not limited to the above secure storage area, and the BIOS 43 and the boot loader 44 may be stored in other storage area.

### 2.2.3. Storage Unit 33

The storage unit 33 stores the first basic software 45 and the second basic software 46. The second basic software 46 is also a part of the OS same as the first basic software 45. In this embodiment, programs included in the OS are classified into a plurality of groups, i.e. the programs are classified into the first basic software 45 and the second basic software 46. However, the number of the classified groups is not limited to two, and may be more than two. Also, the number of the classified groups is not limited to the plural number.

### 2.2.4. SM 34

The SM 34 is a security module including an encryption circuit such as RSA, an operation circuit such as SHA-1 or HMAC, an area in which data is stored, and a random number generation circuit, and the like. As mentioned above, the SM 34 is generally realized by the TPM whose specification is disclosed by the TCG. A detail of the TPM is disclosed in a website of the TCG http://www.trustedcomputinggroup.org. An operation of the SM 34 is provided by a method called Integrity Measurement and a specification of the TPM disclosed by the TCG.

The SM 34 generates an authentication code of the electronic terminal 30 using a hash value received from outside and stores the generated authentication code, which will be specifically described later. The authentication code indicates a measured value of the structure of the electronic terminal 30, and is obtained by PCR extension processing provided by the TCG.

In FIG. 3, a part of the structure of the SM 34 is shown.

I/O 40 is an input/output interface between the SM 34 and outside.

A PCR (Platform Configuration Register) 41 is a storage area including a plurality of registers (PCR1, PCR2, PCR3, . . . ).

A SHA-1 operation unit 42 performs a hash operation. Note that an algorism used for the hash operation is SHA-1, but the hash operation may be performed by other algorism.

### 2.2.5. Terminal Side Control Unit 35

The terminal side control unit 35 is realized because the terminal control program 26 is loaded in the memory of the electronic terminal 30 and executed as mentioned above. Also, the terminal side control unit 35 includes a hash operation unit 47 for performing the hash operation. Here, an algorism used for the hash operation is HMAC, but the hash operation may be performed by other algorism. Then, the terminal side control unit 35 performs processing according to a boot state of the electronic terminal 30, which will be specifically described in an explanation of an operation of the electronic terminal 30.

### 2.2.6. Terminal Side Authentication Unit 36

The terminal side authentication unit 36 is realized because the terminal authentication program is loaded in the memory of the electronic terminal 30 and executed as mentioned above. Also, the terminal side authentication unit 36 performs processing of generating a session key for data exchange with the recording media 10.

### 3. Data

The following describes each data.

### 3.1. Access Setting Table 51

FIG. 4 is a diagram showing the access setting table 51.

The access setting table 51 indicates an accessible range of the secure areas for each boot state of the electronic terminal 30 when the recording media 10 is inserted in the electronic terminal 30. As shown in FIG. 4, the access setting table 51 stores a security strength corresponding to each boot state. The security strength indicates a level of safety that is required when the electronic terminal 30 accesses the data in the secure areas of the recording media 10. For example, when the security strength is “HIGH”, a program that is difficult to be tampered and an algorithm that is more difficult to be decrypted are used in order to exchange data more safely.

In this embodiment, the security strength is highest when the recording media 10 is inserted in the electronic terminal 30 immediately after the electronic terminal 30 is booted. The security strength is used when the terminal judgment unit 16 specifies a terminal authentication program that is outputted to the electronic terminal 30 after judging the validity of the electronic terminal 30.

### 3.2. Program Transmission Setting Table 52

FIG. 5 is a diagram showing the program transmission setting table 52.

The program transmission setting table 52 indicates each combination of a security strength, a terminal authentication program that is outputted to the electronic terminal 30 by the terminal judgment unit 16, and a media side authentication unit corresponding to the terminal authentication program.

As shown in FIG. 5, when the security strength is “HIGH”, the first terminal authentication program 27a is specified by the terminal judgment unit 16. In this case, a media side authentication unit corresponding to the first terminal authentication program 27a is the first media side authentication unit 18a. When the first terminal authentication program 27a is outputted to the electronic terminal 30, the first terminal authentication program 27a is loaded in the memory of the electronic terminal 30 and executed. As a result, the terminal side control unit 35 is realized. Then, the terminal side control unit 35 and the first media side authentication unit 18a perform processing of generating a session key. Note that in this embodiment, in each of combinations of the terminal authentication programs and the media side authentication units, in the case of a combination of the first terminal authentication program 27a and the first media side authentication unit 18a, data exchange can be performed most safely. Also, in the case of a combination of the third terminal authentication program 27c and the third media side authentication unit 18c, data exchange can be performed in the easiest method, i.e. data can be exchanged at a high speed. However, safety of data is lower than the combination of the first terminal authentication program 27a and the first media side authentication unit 18a and a combination of the second terminal authentication program 27b and the second media side authentication unit 18b.

More specifically, a difference of the security strength can be indicated by a length of a shared session key, a difference of a strength of an encryption algorithm that encrypts data exchanged between the recording media and the electronic terminal, or the like. In this embodiment, when the security strength is “LOW”, encrypted information is exchanged between the recording media and the electronic terminal. However, a case in which information is not encrypted and security measures are not especially taken can be defined as the case in which the security strength is “LOW”.

Also, the method of classifying the security strength is not limited to above-mentioned method. For example, the security strength may be classified by whether or not information used for generating a session key is likely to be leaked. In this case, the security strength is HIGH if information recorded in an area that has a tamper resistant or in an ROM area that is not rewritable is used for generating the session key. On the other hand, the security strength is LOW if only information on a general memory is used for generating the session key. Also, in addition to the strength of encryption, the security strength may be classified by whether or not a digital signature is added to exchanged information, or an obfuscation level of a terminal authentication program transmitted to the electronic terminal.

### 3.3. Access Control Table 53

FIG. 6 is a diagram showing the access control table 53.

The access control table 53 stores each secure area requested to be accessed by the electronic terminal 30, and a terminal authentication program that is permitted to access, in correspondence with each other.

For example, as shown in FIG. 6, only the first terminal authentication program 27a is permitted to access from the electronic terminal 30 to the first secure area 21. Similarly, the first terminal authentication program 27a, the second terminal authentication program 27b, and the third terminal authentication program 27c are permitted to access from the electronic terminal 30 to the third secure area 23. In detail, when the third terminal authentication program 27c is outputted to the electronic terminal 30, the electronic terminal 30 cannot access the first secure area 21 and the second secure area 22, but can access the third secure area 23. That is to say, more confidential data is exchanged in a safer method in this embodiment.

### 4. Operation

The following describes an operation of each of the recording media 10 and the electronic terminal 30.

### 4.1. Outline of the Operation of the Electronic Terminal 30

FIG. 7 is a flowchart showing an outline of the operation of the electronic terminal 30.

As shown in FIG. 7, when the operation of the electronic terminal 30 starts, the electronic terminal 30 performs boot processing (S1000). A detail of the boot processing will be described later, with reference to FIG. 8 and the like.

When the boot processing is completed, the electronic terminal 30 executes an application and the like while restricting access to the secure areas (S2000). The processing of restricting the access will be described later, with reference to FIG. 18.

4.2. Boot Processing when the Recording Media 10 is not Inserted in the Electronic Terminal 30

The following specifically describes the boot processing in the step S1000.

FIGS. 8 and 9 are flowcharts showing processing from when a boot of the electronic terminal 30 starts to when the boot thereof is completed.

The following describes an operation of the electronic terminal 30 if the recording media 10 is not inserted in the electronic terminal 30 when a boot of the electronic terminal 30 starts. Note that the electronic terminal 30 operates according to the specification provided by the TCG as mentioned above in this embodiment. More specifically, the electronic terminal 30 performs the “Integrity Measurement” and the processing of extending a PCR.

As shown in FIG. 8, when power is supplied to the electronic terminal 30 (S1), the electronic terminal 30 starts the boot processing. The electronic terminal 30 also starts the boot processing when the system is rebooted. At this time, a value of each PCR of the PCR 41 of the SM 34 is reset to an initial value “0”.

Firstly, in the electronic terminal 30 that starts the boot processing, the CRTM (Core Root of Trust Measurement) written in the boot block of the BIOS 43 is executed, and the CRTM calculates a hash value of the BIOS 43. Here, the calculated hash value of the BIOS 43 is defined as In (BIOS).

The CRTM outputs the calculated hash value In (BIOS) to the SM 34 (S5).

The SM 34 receives the calculated hash value, and performs processing of extending a value of the PCR by performing an operation PCR1=SHA-1 (In (BIOS)). The value on which the extension processing is performed is recorded in a predetermined PCR in the plurality of PCRs. The BIOS 43 corresponds to the PCR1 in this embodiment, and the SM 34 records a value obtained as a result of performing the extension processing on the hash value of the BIOS in the PCR1 (S7). The following simply describes a component corresponding to each PCR in this embodiment. The boot loader 44 corresponds to the PCR2, the first basic software 45 corresponds to the PCR3, and the second basic software 46 corresponds to the PCR4. Note that the processing of extending the PCR is generally performed using an operation PCR (n+1)=SHA-1 (PCR (n)+measured data). Here, the measured data indicates a hash value of the component, and PCR (n+1) indicates a PCR corresponding to the component whose hash value is calculated. Also, PCR (n) indicates a PCR that is calculated immediately before PCR (n+1), i.e. a PCR corresponding to a component that is activated immediately before a component corresponding to PCR (n+1). Moreover, SHA-1 (PCR (n)+measured data) indicates that PCR (n) is connected to measured data, and a hash operation is performed by SHA-1. That is to say, “+” means a connection.

Back to the explanation of the operation, when the value is recorded in the PCR (PCR1) corresponding to the BIOS 43, the BIOS 43 is loaded in the memory to be executed (S9).

When being executed, the BIOS 43 detects a boot loader for booting an OS. Here, when the recording media input-output interface 31 detects that the recording media 10 is inserted in the electronic terminal 30, the BIOS 43 executes a boot using a program of the recording media 10 (“YES” in S11), and when the recording media input-output interface 31 does not detect that the recording media 10 is inserted in the electronic terminal 30, the BIOS 43 executes the boot using the boot loader of the electronic terminal 30 (“NO” in S11). Note that processing (S40) performed when the recording media 10 is inserted in the electronic terminal 30 will be specifically described later. The following describes a case in which the OS is booted by the boot loader 44 of the electronic terminal 30.

In this case, a RTM (Root of Trust Measurement) code included in the BIOS 43 is executed, and a hash value of the boot loader 44 is calculated (S13). Here, the calculated hash value of the boot loader 44 is defined as In (BL). The RTM outputs the calculated hash value In (BL) to the SM 34 (S15). The SM 34 receives the hash value, and performs processing of extending the PCR by performing an operation PCR2=SHA-1 (PCR1+In (BL)). The value on which the extension processing is performed is recorded in the PCR2 corresponding to the boot loader 44 (S17).

When the value is recorded in the PCR (PCR2) corresponding to the boot loader 44, the boot loader 44 is loaded in the memory to be executed (S19).

The explanation will be continued based on FIG. 9.

When the boot loader 44 is executed, a RTM code of the boot loader 44 is executed, and a hash value of the first basic software 45 is calculated (S21). Here, the calculated hash value of the first basic software 45 is defined as In (OS1). The RTM outputs the calculated hash value In (OS1) to the SM 34 (S23).

The SM 34 receives the hash value, and performs processing of extending the PCR by performing an operation PCR3=SHA-1 (PCR2+In (OS1)). The value on which the extension processing is performed is recorded in the PCR3 corresponding to the first basic software 45 (S25).

When the value is recorded in the PCR (PCR3) corresponding to the first basic software 45, the first basic software 45 is loaded in the memory to be executed by the boot loader 44 (S27).

When the first basic software 45 is executed, a RTM code of the first basic software 45 is executed, and a hash value of the second basic software 46 is calculated (S29).

Here, the calculated hash value of the second basic software 46 is defined as In (OS2). The RTM outputs the calculated hash value In (OS2) to the SM 34 (S31). The SM 34 receives the hash value, and performs processing of extending the PCR by performing an operation PCR4=SHA-1 (PCR3+In (OS2)). The value on which the extension processing is performed is recorded in the PCR4 corresponding to the second basic software 46 (S33). When the value is recorded in the PCR (PCR4) corresponding to the second basic software 46, the second basic software 46 is loaded in the memory to be executed (S35).

4.3. Operation of the Electronic Terminal 30 when the Recording Media 10 is Inserted in the Electronic Terminal 30

The above explanation is about the operation of the electronic terminal 30 when the recording media 10 is not inserted in the electronic terminal 30. The following simply describes an operation of the electronic terminal 30 when the recording media 10 is inserted in the electronic terminal 30 after the boot loader 44 has been activated. As shown by an operation of the electronic terminal 30 in which the boot loader has been booted in FIG. 10, when the recording media input-output interface 31 detects that the recording media 10 is inserted in the electronic terminal 30 after the boot loader 44 has been activated (S37), the electronic terminal 30 performs the processing when the recording media 10 is inserted in the electronic terminal 30 (S40).

4.4. Detail of Processing when the Recording Media 10 is Inserted in the Electronic Terminal 30

The following describes a detail of the processing in the step S40 shown in FIGS. 8 and 10, with reference to FIG. 11 and the like.

FIGS. 11 and 12 are flowcharts showing an operation of each of the recording media 10 and the electronic terminal 30 when the recording media 10 is inserted in the electronic terminal 30. The following is an outline. The recording media 10 mainly performs (i) processing of judging a boot state of the electronic terminal 30 when the recording media 10 is inserted therein, and (ii) processing of verifying validity of the electronic terminal 30. Also, the recording media 10 performs different processing according to a point of time when the recording media 10 is inserted in the electronic terminal 30.

As shown in FIG. 11, when the electronic terminal 30 detects that the recording media 10 is inserted in the electronic terminal 30, the electronic terminal 30 reads the terminal control program 26 from the recording media 10. The terminal side control unit 35 is realized by loading the read terminal control program 26 in the memory (S41).

Then, the terminal side control unit 35 of the electronic terminal 30 and the recording media 10 perform processing of judging a boot state of the electronic terminal 30 (S43 and S45). Details of the steps S43 and S45 will be described later, with reference to FIGS. 13 to 15. After performing the steps S43 and S45, a judgment result of the boot state is stored in the boot procedure recording unit 13 as a boot state flag.

Also, the terminal side control unit 35 (the terminal control program 26 executed in the electronic terminal 30) controls a calculation method of a hash value of the first basic software 45, the second basic software 46, or the like based on the judgment result of the boot state (S47). A detail of the step S47 will be described later, with reference to FIGS. 15 to 17.

When the second basic software 46 is activated (S35), the terminal side control unit 35 outputs a value of the PCR (PCR4) corresponding to the second basic software 46 to the recording media 10 as an authentication code (S49). When the boot state of the electronic terminal 30 is judged to be “in the middle of a boot” or “after the completion of a boot” in the step S43, the electronic terminal 30 stores the hash value of the terminal control program 26 that is loaded in the step S41 in a predetermined storage area in the step S47, which will be described later in the detailed explanation of the step S47. Also, when the boot state of the electronic terminal 30 is judged to be “in the middle of a boot” or “after the completion of a boot”, the electronic terminal 30 outputs the hash value of the terminal control program 26 in addition to the authentication code to the recording media 10 in the step S49. Note that this hash value is used for verifying validity of the terminal control program 26 in processing of verifying validity in a step S51 which will be described later. When the boot state of the electronic terminal 30 is judged to be “after the completion of a boot” in the steps S43 and S45, the value of the PCR4 transmitted for judging the boot state can be used as the authentication code. Therefore, it is not required to transmit the value of the PCR4 in the step S49.

The explanation will be continued based on FIG. 12.

When the recording media 10 receives the authentication code transmitted from the electronic terminal 30, the terminal judgment unit 16 judges the validity of the electronic terminal 30 (S51). When the boot state of the electronic terminal 30 is judged to be “in the middle of a boot” or “after the completion of a boot”, the hash value of the terminal control program 26 is also outputted from the electronic terminal 30. Therefore, the recording media 10 judges whether or not the terminal control program 26 is valid using the hash value. More specifically, the recording media 10 has recorded a hash value of each terminal control program. Therefore, the recording media 10 judges validity of the terminal control program by confirming whether or not the hash value received from the electronic terminal 30 is identical to the recorded hash value.

When the electronic terminal 30 is judged to be invalid (“NO” in S53), the recording media 10 stores a setting of prohibiting access to the secure areas in the access control unit 19, because the electronic terminal 30 is invalid (S55). In the same manner as this, when the terminal control program 26 is judged to be invalid, the recording media 10 stores a setting of prohibiting access to the secure areas in the access control unit 19 (S55).

In the step S51, when the electronic terminal 30 is judged to be valid (“YES” in S53) (if validity of the terminal control program 26 is judged, when the terminal control program 26 is judged to be valid and the electronic terminal 30 is judged to be valid), the terminal judgment unit 16 refers to a numerical value of the boot state flag that is stored in the boot procedure recording unit 13 in the step S43, and obtains information about a boot state judged by the terminal state judgment unit 12, out of the boot states “at the beginning of a boot”, “in the middle of a boot” and “after the completion of a boot”. Also, the terminal judgment unit 16 obtains a security strength corresponding to a judgment result by the terminal state judgment unit 12 by referring to the access setting table 51. For example, when the judgment result is “at the beginning of a boot”, the security strength is “HIGH”. Then, the terminal judgment unit 16 specifies a terminal authentication program and a media side authentication unit corresponding to the obtained security strength, by referring to the program transmission setting table 52. For example, when the security strength is “HIGH”, the terminal judgment unit 16 specifies the first terminal authentication program 27a and the first media side authentication unit 18a.

The execution unit 15 of the recording media 10 outputs the terminal authentication program specified by the terminal judgment unit 16 (for example, the specified terminal authentication program is the first terminal authentication program 27a when the judgment result by the terminal state judgment unit 12 is “at the beginning of a boot” in the step S43) to the electronic terminal 30 (S57).

The electronic terminal 30 receives the terminal authentication program outputted from the recording media 10, and realizes the terminal side authentication unit 36 (S59). The terminal side authentication unit 36 performs predetermined processing of safely exchanging data in the secure areas, such as processing of sharing a session key with the media side authentication unit of the recording media 10 (S61).

Also, the execution unit 15 of the recording media 10 causes the access control unit 19 to store which terminal authentication program was outputted to the electronic terminal 30 (S63).

Then, the execution unit 15 of the recording media 10 boots the media side authentication unit specified by the terminal judgment unit 16, and performs the predetermined processing described in the step S61 with the terminal side authentication unit 36 of the electronic terminal 30 (S65).

### 4.5. Processing of Judging Boot State

The following describe details of the steps S43 and S45, i.e. a detail of processing of judging a boot state of the electronic terminal 30.

FIG. 13 is a flowchart showing an operation of the electronic terminal 30 and judgment processing of a boot state of the electronic terminal 30 that is performed by the terminal state judgment unit 12. As shown in FIGS. 8 and 9, the electronic terminal 30 records a value in each PCR when the electronic terminal 30 is booted. In view of this point, the terminal state judgment unit 12 judges the boot state of the electronic terminal 30 based on whether or not a value is recorded in a predetermined PCR corresponding to the BIOS 43 and the like when the recording media 10 is inserted in the electronic terminal 30, i.e. based on whether or not a value of the PCR is an initial value “0” in this embodiment. Note that the case in which the value of the PCR is not the initial value “0” is described as “the PCR has a value”, and the case in which the value of the PCR is the initial value “0” is described as “the PCR does not have a value”.

More specifically, the terminal side control unit 35 of the electronic terminal 30 outputs a value of at least one PCR corresponding to each program that is activated when the boot processing of the electronic terminal 30 is performed to the recording media 10 (S67). The following simply describes a value of a PCR that should be outputted from the electronic terminal 30 to the recording media 10. FIG. 15 is a diagram showing a PCR corresponding to each program that is activated when the boot processing is performed. The terminal state judgment unit 12 can judge that the second basic software 46 is activated when the PCR4 has a value. The terminal state judgment unit 12 can judge that the second basic software 46 is not activated and the first basic software 45 is activated when the PCR4 does not have a value and the PCR3 has a value. The terminal state judgment unit 12 can judge that the first basic software 45 is not activated and the boot loader 44 is activated when the PCR3 does not have a value and the PCR2 has a value. The terminal state judgment unit 12 can judge that the boot loader 44 is not activated when the PCR2 does not have a value. In this embodiment, out of the PCRs, the PCR2 corresponding to the boot loader 44, the PCR3 corresponding to the first basic software 45, and the PCR4 corresponding to the second basic software 46 are outputted from the electronic terminal 30 to the recording media 10. This is because the terminal state judgment unit 12 can judge the three states “at the beginning of a boot”, “in the middle of a boot”, and “after the completion of a boot” if the PCR2, the PCR3, and the PCR4 are outputted to the recording media 10.

In this embodiment, the PCR2, the PCR3, and the PCR4 are outputted from the electronic terminal 30 to the recording media 10. However, the present invention is not limited to this, and a value of any one of the PCRs may be outputted. For example, if a value of the PCR4 is outputted, the recording media 10 can judge whether or not the electronic terminal 30 is “after the completion of a boot”. That is to say, access to the secure areas can be restricted based on these two types of judgment results.

Back to the explanation of the judgment processing of the boot state, when a value of the predetermined PCR (the PCR2, the PCR3, and the PCR4 in this embodiment) is outputted from the electronic terminal 30 to the recording media 10 in the step S67, the recording media 10 judges the boot state of the electronic terminal 30 according to a value of each PCR in the terminal state judgment unit 12 (S69).

The following describes a detail of the step S69.

FIG. 14 is a flowchart showing the detail of the judgment processing of the boot state.

The terminal state judgment unit 12 of the recording media 10 obtains the value of the PCR (the PCR2, the PCR3, and the PCR4) outputted from the electronic terminal 30 in the step S67 (S73).

Then, the terminal state judgment unit 12 judges whether or not the PCR4 has a value, i.e. whether or not a value of the PCR4 is “0” (S75).

When judging that the PCR4 has a value (“YES” in S75), the terminal state judgment unit 12 determines that the electronic terminal 30 is “after the completion of a boot” because the second basic software 46 is activated, and sets a boot state flag in the boot procedure recording unit 13 to indicate “after the completion of a boot” (S79). In this embodiment, the boot state flag is set to “3”.

When judging that the PCR4 does not have a value in the step S75 (“NO” in S75), the terminal state judgment unit 12 judges whether or not the PCR3 has a value (S77).

When judging that the PCR3 has a value (“YES” in S77), the terminal state judgment unit 12 determines that the electronic terminal 30 is “in the middle of a boot” because the second basic software 46 is not activated and the first basic software 45 is activated, and sets a boot state flag in the boot procedure recording unit 13 to indicate “in the middle of a boot” (S81). In this embodiment, the boot state flag is set to “2”.

When judging that the PCR3 does not have a value in the step S77 (“NO” in S77), the terminal state judgment unit 12 judges whether or not the PCR2 has a value (S78).

When judging that the PCR2 has a value in the step S78 (“YES” in S78), the terminal state judgment unit 12 determines that the electronic terminal 30 is “in the middle of a boot”, and sets a boot state flag in the boot procedure recording unit 13 to indicate “in the middle of a boot” (S81). In this embodiment, the boot state flag is set to “2”.

When judging that the PCR2 does not have a value in the step S78 (“NO” in S78), the terminal state judgment unit 12 determines that the electronic terminal 30 is “at the beginning of a boot”, and sets a boot state flag in the boot procedure recording unit 13 to indicate “at the beginning of a boot” (S83). In this embodiment, the boot state flag is set to “1”.

This is the details of the processing in the steps S43 and S45.

### 4.6. Detail of Processing of the Terminal Control Program 26

The following describes a detail of the processing in the step S47.

FIGS. 16 and 17 are flowcharts showing processing of controlling a calculation target of a hash value, which is performed by the terminal control program 26 executed by the electronic terminal 30 after the judgment processing of the boot state is completed. In other words, in the following processing, the terminal control program 26 calculates a hash value of a program that is not activated out of the programs relating to the boot processing of the electronic terminal 30, instead of each of the programs of the electronic terminal 30. For example, if the recording media 10 is inserted in the electronic terminal 30 when the electronic terminal 30 is booted (i.e. when the first basic software 45 has not been activated), the terminal control program 26 calculates a hash value of the first basic software 45 instead of the boot loader 44.

As shown in FIG. 16, the terminal control program 26 executed by the electronic terminal 30 (the terminal side control unit 35 including the hash operation unit 47) firstly calculates a hash value of the terminal control program 26 itself (S85). This hash value may be used for verifying validity of the terminal control program 26 itself. Note that the terminal control program 26 calculates the hash value using the HMAC algorithm as mentioned above.

The terminal control program 26 obtains the boot state flag stored in the boot procedure recording unit 13 from the recording media 10 (S87).

(i) When the boot state flag obtained by the terminal control program 26 in the step S87 indicates “at the beginning of a boot” (“at the beginning of a boot” in S89), the terminal control program 26 outputs the hash value of the terminal control program 26 itself calculated in the step S85 to the SM 34 (S91). That is to say, when the boot state flag indicates “at the beginning of a boot”, the BIOS 43 is activated and the boot loader 44 is not activated in the electronic terminal 30. Therefore, the terminal control program 26 activates the first basic software 45 instead of the boot loader 44. Then, the terminal control program 26 transmits the hash value of the terminal control program 26 to the SM 34 instead of the hash value of the boot loader 44. As shown in FIG. 15, the SM 34 receives the hash value of the terminal control program 26, and defines the hash value as In (BL) to perform the processing of extending a value of the PCR by performing the operation PCR2=SHA-1 (PCR1+In (BL)). The terminal control program 26 records the value on which the extension processing has been performed in the PCR2 corresponding to the boot loader 44 (S93).

When the value is recorded in the PCR2, the terminal control program 26 calculates a hash value of the first basic software 45 (S95). Then, the terminal control program 26 outputs the calculated hash value to the SM 34 (S97). Here, the calculated hash value is defined as In (OS1). The SM 34 receives the hash value, and performs the processing of extending a value of the PCR by performing the operation PCR3=SHA-1 (PCR2+In (OS1)). The terminal control program 26 records the value on which the extension processing has been performed in the PCR3 corresponding to the first basic software 45 (S99). This processing is substantially same as the step S25 except that the subject that calculates the hash value of the first basic software 45 is different.

Then, processing of loading the first basic software 45 to execute (S101) and the like. The processing in the step S101 is same as the processing in the step S27, and in the same manner as this, processing in the steps from S103 to S105, S107, and S109 in FIG. 17 are same as the processing in the steps S29, S31, S33, and S35 in FIG. 9. Therefore, the explanation of the above processing is omitted.

(ii) When the boot state flag obtained by the terminal control program 26 in the step S87 indicates “in the middle of a boot” (“in the middle of a boot” in S89), the terminal control program 26 causes a predetermined PCR of the SM 34 to store the hash value of the terminal control program 26 itself calculated in the step S85. Note that this hash value is used for judging whether or not the terminal control program 26 itself is valid in the processing in the step S51.

When the boot state flag indicates “in the middle of a boot”, the first basic software 45 is activated and the second basic software 46 is not activated in the electronic terminal 30. Therefore, the terminal control program 26 calculates a hash value of the second basic software 46 instead of the first basic software 45 (S113). Then, the terminal control program 26 performs the processing in the steps S105, S107, and S109. In the case of (ii), the hash value of the second basic software 46 calculated in the step S105 is outputted to the SM 34 by the terminal control program 26.

(iii) When the boot state flag obtained by the terminal control program 26 in the step S87 indicates “after the completion of a boot” (“after the completion of a boot” in S89), the terminal control program 26 causes a predetermined PCR to store the hash value of the terminal control program 26 itself as same in the step S111 (S115).

Although the terminal control program 26 causes the predetermined PCR to store the hash value of the terminal control program 26 itself in the steps S111 and S115, the area in which the hash value is stored is not limited to the PCR. For example, the hash value may be stored in other area such as a memory in the electronic terminal 30 other than the PCR.

In the above-mentioned processing, the terminal control program 26 calculates a hash value of the second basic software 46 instead of the first basic software 45. This is because of the following reason. Since a source of a program recorded in the recording media 10 is clear in most cases for the recording media 10, the program has higher reliability than the program in the electronic terminal 30 for the recording media 10.

As mentioned above, the recording media 10 performs the boot processing of the electronic terminal 30 and verifies the validity of the electronic terminal 30.

### 4.7. Processing Relating to Access Restriction

The following describes an operation of the electronic terminal 30 after the boot processing has been completed (S2000). Because there are various methods of restricting access to the memory area, an example thereof will be described here.

FIG. 18 is a flowchart showing access control processing performed by the access control unit 19. Note that the access control unit 19 stores the access control table 53. Also, the access control unit 19 stores a setting of prohibiting access to the secure areas in the step S55 or stores which terminal authentication program was outputted to the electronic terminal 30 from the recording media 10 in the step S63.

As shown in FIG. 18, when detecting a request for accessing the secure areas from the electronic terminal 30 (S117), the access control unit 19 judges whether or not a setting of prohibiting access to the secure areas is stored in the step S55 (S119).

When the access is prohibited (“YES” in S119), the access control unit 19 denies the request for accessing the secure areas from the electronic terminal 30 (S127).

When the access is not prohibited (“NO” in S119), the access control unit 19 refers to the access control table 53 to confirm a terminal authentication program to which access is permitted corresponding to a secure area requested to be accessed by the electronic terminal 30. Then, the access control unit 19 judges whether or not a terminal authentication program stored in the step S63 is included in the terminal authentication program to which access is permitted (S121). For example, when a secure area requested to be accessed by the electronic terminal 30 is the first secure area 21 as shown in FIG. 18, the access control unit 19 judges whether or not a terminal authentication program stored in the step S63 is the first terminal authentication program 27a.

When a result of the judgment is affirmative (“YES” in S123), the access control unit 19 permits access from the electronic terminal 30, encrypts data in the secure area using the session key generated by the terminal side authentication unit 36 and the media side authentication unit, and outputs the encrypted data to the electronic terminal 30 (S125).

When a result of the judgment is negative (“NO” in S123), the access control unit 19 denies access from the electronic terminal 30 (S127).

### 4.8. Access Setting

In the explanation of the access setting recording unit 14, it has been explained that a user can customize whether or not access to the secure areas is permitted. The following describes a method of updating the access setting table 51 based on the customization.

A user of the electronic terminal 30 inserts the recording media 10 in the electronic terminal 30, and executes the access setting program stored in the program storage area 24 in the electronic terminal 30. The user updates the access setting table 51 through the access setting program. More specifically, the user updates “security strength” and “accessible secure area” each corresponding to “boot state when media is inserted in electronic terminal” in the access setting table 51. For example, in FIG. 4, when the boot state is “in the middle of a boot”, access to the second secure area 22 and the third secure area 23 is permitted. However, the user can change a setting so that “accessible secure area” is only the second secure area 22.

Also, the user can update “security strength” through the access setting program. For example, when the boot state is “at the beginning of a boot”, it is judged that reliability of verifying validity of the electronic terminal 30 is high, the security strength is set to “LOW”, and data in the first secure area 21 is exchanged in a simple authentication method. Also, when the boot state is “after the completion of a boot”, the security strength is set to “HIGH” in order to safely exchange data between the electronic terminal 30 and the recording media 10. Moreover, a same security strength may be set with regard to a plurality of boot states. For example, the security strength may be set to “HIGH” in any boot state.

Since it is preferable that the access setting table 51 is updated in a safe environment, the following condition can be set as a requirement for executing the access setting program. The condition is that the recording media 10 is inserted in the electronic terminal 30 from a point of time when power is supplied to the electronic terminal 30, i.e. it is judged to be “YES” in the step S11. Also, in order to update the access setting table 51 in a safer environment, the validity of the electronic terminal 30 may be verified by the processing in the step S49 and the like when the access setting program is activated, and execution of the access setting program may be permitted only when the electronic terminal 30 is valid.

Although the access setting table 51 can be customized by the user in the above-mentioned embodiment, a predetermined setting can be configured in the access setting table 51 before factory shipment.

### CONCLUSION

In the present invention, if a terminal has a boot function from an external apparatus and an automatic execution function when a recording medium is inserted, each of which is included in a general PC or the like, the terminal control program 26 and the like can be activated from the recording media 10 by using these functions, and judgment of the boot state and the like can be performed. That is to say, the present invention can be realized without providing a particular client device.

### <Modification>

The following describes modifications of the present invention.

(1) Subject that Verifies Validity of the Electronic Terminal 30

### (1-1) Verification by External Device

As described in the above “4.4. Detail of processing when the recording media 10 is inserted in the electronic terminal 30”, when the recording media 10 is inserted in the electronic terminal 30, the recording media 10 mainly performs (i) processing of judging a boot state of the electronic terminal 30 when the recording media 10 is inserted therein, and (ii) processing of verifying validity of the electronic terminal 30. The following describes a modification of (ii) processing of verifying validity of the electronic terminal 30.

In the above embodiment, as shown by the step S51 in FIG. 12, the terminal judgment unit 16 of the recording media 10 judges whether or not the electronic terminal 30 is valid. However, the present invention is not limited to this, and a verifier that verifies the validity of the electronic terminal 30 may be other than the recording media 10, such as the server 1. In this case, the electronic terminal 30 outputs the authentication code generated by the SM 34 in the step S49 to the server 1 via a network or the like, instead of the recording media 10. Also, the server 1 performs authentication (corresponding to the processing in the step S51), and outputs information indicating whether or not the electronic terminal 30 is valid to the recording media 10 via the electronic terminal 30.

Note that not only (ii) processing of verifying validity of the electronic terminal 30 but also (i) processing of judging a boot state of the electronic terminal 30 when the recording media 10 is inserted therein can be performed by an external device such as the server 1. In detail, the server 1 includes the terminal state judgment unit 12 and the boot procedure recording unit 13, and after the server 1 judges the boot state of the electronic terminal 30, a result of the judgment is notified to the recording media 10 from the server 1. More specifically, the electronic terminal 30, the recording media 10, and the server 1 perform processing shown in FIG. 19 instead of the processing in the steps S43 and S45 in FIG. 11 and the processing shown in FIG. 13.

FIG. 19 is a flowchart showing judgment processing of the boot state of the electronic terminal 30, which is performed by an external device. In the example in FIG. 19, the external device is the sever 1.

The following is a difference between the processing in FIG. 19 and the processing in FIG. 13. A value of each PCR for judging the boot state of the electronic terminal 30 is outputted from the electronic terminal 30 to the server 1, the boot state is judged by the server 1, and a result of the judgment is notified to the recording media 10 from the server 1 via the electronic terminal 30.

The following specifically describes processing after the processing in the step S41 in FIG. 11 is performed, with reference to FIG. 19. The terminal side control unit 35 of the electronic terminal 30 that is realized in the step S41 outputs a value of at least one PCR corresponding to each program that is activated when the boot processing of the electronic terminal 30 is performed, to the server 1 via a network 2 (S67-1). A difference between this processing and the processing in the step S67 is that the value of the PCR is outputted to the server 1, not to the recording media 10. Because a value of a PCR that should be outputted has been described in the explanation of the step S67, the explanation will be omitted here.

The following describes subsequent processing. When the value of the predetermined PCR is outputted from the electronic terminal 30 in the step S67-1, the server 1 performs the same processing shown in FIG. 14 to judge the boot state of the electronic terminal 30 according to a value of each PCR (S68). Since a detail of this judgment processing is same as the processing shown in FIG. 14 in which the recording media 10 is replaced with the server 1, the explanation will be omitted.

When a judgment result of the boot state in the step S68 is held by the server 1 as the boot state flag, the server 1 notifies the electronic terminal 30 of the judgment result, i.e. the boot state flag via the network 2 (S70).

The electronic terminal 30 receives the boot state flag notified by the server 1, and notifies the recording media 10 of the boot state flag (S71).

When receiving the boot state flag from the electronic terminal 30, the recording media 10 holds the received boot state flag in the boot procedure recording unit 13.

As mentioned above, (i) processing of judging a boot state of the electronic terminal 30 when the recording media 10 is inserted therein can be performed by an external device such as the server 1.

Also, the network may be unsafe when (i) processing of judging a boot state of the electronic terminal 30 when the recording media 10 is inserted therein and (ii) processing of verifying validity of the electronic terminal 30 are performed by an external device that is connected via a network as mentioned above. Therefore, information such as the judgment result of the boot state, the authentication result of the validity of the electronic terminal 30, or the like is likely to be tampered when being notified to the recording media 10 from the external device. Thus, processing of detecting tampering may be performed on the information that is notified to the recording media 10 from the external device. For example, a digital signature made by a secret key of the external device that notifies the recording media 10 of the information may be added to the notified information, and the recording media 10 may verify the information using a public key of the external device.

### (1-2) Verification by Program Supplied to the Electronic Terminal 30

For example, information about a valid authentication code (more specifically, each authentication code held by the terminal judgment unit 16) may be included in a program supplied to the electronic terminal 30 from the recording media 10 such as the terminal control program 26, and this program executed in the electronic terminal 30 (program with a verification function) may perform processing corresponding to the processing in the step S51 based on the authentication code held by the program in the electronic terminal 30, instead of the terminal judgment unit 16. In this case, it is required to protect the program with the verification function in order to prevent the authentication code from being tampered in the electronic terminal 30. However, it is not required that the recording media 10 includes a structure for verifying the validity of the electronic terminal 30. Therefore, the present invention can be applied to various recording media.

### (2) Display of Boot Method

In addition to the operation in the above embodiment, when the recording media 10 is inserted in the electronic terminal 30, the electronic terminal 30 may display a plurality of choices of boot methods on a monitor or the like for a user to choose one of the boot methods, for example. The following are examples of the choices of boot methods.

(i) Full secure boot: perform processing when the electronic terminal 30 is rebooted and the recording media 10 is inserted in the electronic terminal 30 from a point of time when power is supplied to the electronic terminal 30
(ii) Secure boot: perform processing according to a boot state judged when the recording media 10 is inserted in the electronic terminal 30
(iii) Normal boot: perform processing without authentication processing

When (i) Full secure boot is executed, the electronic terminal 30 is rebooted. Then, it is judged to be “YES” in the step S11 in FIG. 8, and the boot state flag is set to “at the beginning of a boot”. Therefore, the user can access a secure area corresponding to “at the beginning of a boot”. When (ii) Secure boot is executed, the user can access a secure area corresponding to the boot state. When (iii) Normal boot is executed, the electronic terminal 30 prohibits at least execution of the authentication processing. As a result, the authentication processing in the step S49 and the like are not performed, and thus the processing of generating a session key for exchanging data in the secure areas is not also performed. Therefore, the user cannot access the data in the secure areas. Also, because the user cannot access the data in the secure areas, it is not required to judge the boot state. Thus, the processing in the steps S43 and S45 may not be performed. Moreover, if it is not required to load the terminal control program 26, the processing in the step S41 is not required to be performed.

If the choices of boot methods are displayed as mentioned above, when a user would like to access data, for example, in the general area 25 of the recording media 10, the user may choose (iii) Normal boot. This enables the user to immediately access the data in the general area 25 of the recording media 10 compared with (i) Full secure boot and (ii) Secure boot, because the authentication processing is not performed. Therefore, convenience of the recording media 10 is improved.

In the same manner as this, immediately after power is supplied to the electronic terminal 30, the user may choose either a choice of performing (i) Full secure boot or a choice of performing (iii) Normal boot, by displaying the choices on a monitor. This can be realized by displaying the choices before the BIOS activates the boot loader. Since the authentication processing is performed in the case of (i) Full secure boot as mentioned above, it requires more time to boot the electronic terminal 30 than (iii) Normal boot. Therefore, by displaying the choices, convenience of the recording media 10 is improved in this case. Note that this operation may be performed only when the recording media 10 is inserted in the electronic terminal 30 before power is supplied to the electronic terminal 30, or may be performed when the recording media 10 is not inserted in the electronic terminal 30. However, (i) Full secure boot can be performed only when the recording media 10 is inserted in the electronic terminal 30. Therefore, if (i) Full secure boot is chosen when the recording media 10 is not inserted in the electronic terminal 30, it is preferable to display an alarm screen or the like that prompts a user to insert the recording media 10 in the electronic terminal 30.

### (3) Combination Number of Terminal Authentication Program and Media Side Authentication Unit

In the above explanation, the number of combinations of the terminal authentication program and the media side authentication unit is three. This is because the terminal state judgment unit 12 judges three states “at the beginning of a boot”, “in the middle of a boot”, and “after the completion of a boot”, and authentication methods each having a different security strength are provided according to each of the three states.

Therefore, it is not required to provide a plurality of terminal authentication programs, and data can be exchanged, for example, in a method common to all security strengths (i.e. the security strength is not classified). In this case, the operation of the terminal side authentication unit 36 is determined without the recording media 10. Therefore, it is easy to install the terminal side authentication unit 36 in the electronic terminal 30 in advance.

### (4) Classification of Boot State

In the above explanation, especially in the explanation of the terminal state judgment unit 12, the boot state is classified into three states, i.e. “at the beginning of a boot”, “in the middle of a boot”, and “after the completion of a boot”. However, the classification of the boot state is not limited to the above three states. For example, in most cases, the recording media 10 is inserted in the electronic terminal 30 from when power is supplied to the electronic terminal 30, or after the electronic terminal 30 completes a boot of an OS (i.e. it is less likely that the recording media 10 is inserted in the electronic terminal 30 in the middle of the boot of the OS). In view of the above possibility, the terminal state judgment unit 12 may not judge the case of “in the middle of a boot”. In this case, the terminal state judgment unit 12 judges the two states “at the beginning of a boot” and “after the completion of a boot”.

Also, the boot stages of the OS may be more finely classified into a plurality of stages, and the terminal state judgment unit 12 may judge more boot states. When providing a different security strength according to each state in this case, a combination of a terminal side authentication program and a media side authentication unit is provided in correspondence with each state.

As an example of the case of “in the middle of a boot”, there may be a case in which the recording media 10 is inserted in the electronic terminal 30 when the electronic terminal 30 is in a suspend state after the first basic software 45 is loaded in a memory, and a boot of the electronic terminal 30 is resumed from a point of time when the second basic software 46 is loaded. Such a method is used when it is required to boot the electronic terminal 30 at a high speed.

Also, as an example of other boot state, the following boot states can be taken. For example, a boot from a standby state (processing of switching to a power saving mode after recording information before interruption on a memory in order to return to an original state later), a boot from a hibernation state (processing of turning off the power after recording information before interruption in a hard disk and the like in order to return to an original state later), or the like can be taken.

### (5) Secure Area

The secure areas are classified into three areas, i.e. the first secure area 21, the second secure area 22, and the third secure area 23 in the above explanation. However, the number of the secure areas is not limited to three, and may be one, or more than three.

Also, the first secure area 21, the second secure area 22, and the third secure area 23 can be installed as separate hardware. In this case, even if protection of data, for example, in the first secure area 21 is broken, the other areas can be secured by protecting the first secure area 21, the second secure area 22, and the third secure area 23 in separate methods of hardware.

Moreover, the first secure area 21, the second secure area 22, and the third secure area 23 can be realized by using the secure area that is realized as one hardware separately for each address range. In this case, a size of each area can be flexibly changed by changing an address range that is assigned to each area. Therefore, if a large amount of data is required to be protected, an area used for the case in which the security strength is “HIGH” can be expanded, or an area which a user can access in the case of “at the beginning of a boot” can be expanded. On the other hand, if a small amount of data is required to be protected, an area used for the case in which the security strength is “LOW” can be expanded.

With regard to an area to which access permission is given even in the case in which the security strength is “LOW”, such as the third secure area 23, data can be exchanged without performing safe communication using the terminal authentication program and the like.

In the above embodiment, the access control unit 19 is provided to restrict access to the secure areas. In addition to the access control unit 19, the following can be taken as a method of restricting access to the memory area. For example, a function of restricting access to the secure areas may be installed in the electronic terminal 30 as a program, and the electronic terminal 30 restricts the access by executing the program. In other words, a subject that restricts the access switches from the recording media 10 to the electronic terminal 30. In this case, this program restricts the access by referring to the access control table 53 and the like in the recording media 10. Note that a part of a function, i.e. a function of the access control unit 19 can be omitted from the recording media 10 in this case.

(6) Subject that Calculates Authentication Code

In the above embodiment, the SM 34 calculates the authentication code transmitted from the electronic terminal 30 to the recording media 10. However, a subject that calculates the authentication code is not limited to the SM 34, and may be other component. For example, a program that is supplied from the recording media 10 to the electronic terminal 30 can calculate the authentication code. In this case, the electronic terminal 30 is not required to have a particular structure of calculating the authentication code, such as hardware. Therefore, it is easy to put the present invention into practice.

### (7) Method of Verifying Validity

In the above embodiment, the electronic terminal 30 operates according to the specification provided by the TCG, and validity of the electronic terminal 30 is verified using a value of a PCR on which the extension processing is performed. However, the method of verifying the validity of the electronic terminal 30 is not limited to this. For example, the validity of the electronic terminal 30 can be verified by comparing a hash value of each of a plurality of components (such as a program) that are activated in stages according to the boot processing of the electronic terminal 30 with a predetermined authentication code. For example, the validity of the electronic terminal 30 can be verified by calculating a hash value of the OS of the electronic terminal 30 (the first basic software 45 and the second basic software 46) and comparing the calculated hash value with a hash value in the case in which the OS is valid.

In the above embodiment, the authentication code is generated in the SM 34 by performing the extension processing of the PCR and using all programs relating to the boot processing such as the boot loader 44, the first basic software 45, and the second basic software 46. However, it is not required to use all of the programs, and a part of the programs can be omitted.

Also, the validity of the electronic terminal 30 can be verified by a method other than the method of comparing the authentication code, such as a method that can confirm the validity of the electronic terminal 30.

(8) Subject that Judges Boot State

In the above embodiment, the terminal state judgment unit 12 of the recording media 10 judges the boot state of the electronic terminal 30 based on the predetermined information that is outputted from the electronic terminal 30 (the value of the predetermined PCR in the above embodiment). However, the subject that judges the boot state is not limited to the recording media 10. For example, the subject may be the electronic terminal 30 and an external device. For instance, a function of judging the boot state may be included in a program that is supplied from the recording media 10 to the electronic terminal 30 (such as the terminal control program 26), and the processing in the step S69 that judges the boot state of the electronic terminal 30 can be performed in the electronic terminal 30.

### (9) Content of Boot Processing

In the above embodiment, when the recording media 10 is inserted in the electronic terminal 30 immediately after a boot of the electronic terminal 30 starts, the first basic software 45 is activated by the terminal control program 26, and then the processing is performed by the first basic software 45 and the second basic software 46 in the electronic terminal 30. However, the booted OS is not limited to the OS held by the electronic terminal 30.

For example, the recording media 10 may hold a program having a function of the OS in the electronic terminal 30, and the terminal control program 26 that is read by the BIOS 43 to the electronic terminal 30 may read the program having the function of the OS from the recording media 10 to the electronic terminal 30 and activate the program. For instance, a code having a function of the OS may be included in the terminal control program 26 itself.

As a result, the electronic terminal 30 operates according to only the program held by the recording media 10. Therefore, data that should be protected can be prevented from being stolen from the secure areas regardless of whether or not the first basic software 45 of the electronic terminal 30 is tampered.

### (10) Recording Device

In the above embodiment, the recording device of the present invention has been described by taking an example of a portable recording media in particular. However, the recording device of the present invention is not limited to this, and may be a magnetic disk such as a HDD (Hard Disk Drive) and a flash memory. An external HDD corresponding to a data transmission standard such as a USB (Universal Serial Bus) has been widely distributed. Also, the recording device may be included in the electronic terminal 30.

In the above explanation, the recording device has been described as the recording device 10 that is inserted in the electronic terminal 30. However, it is not necessarily required that the recording device and the electronic terminal 30 perform data communication so as to contact with each other. The recording device may be a recording device that exchanges data using a wireless signal such as a non-contact type IC card in which a CPU and a coprocessor are installed.

In addition to the above recording device, the recording device of the present invention may be a recording device that is connected to the electronic terminal 30 via a network such as a LAN (Local Area Network) and the Internet, and can boot the electronic terminal 30 in the network.

For example, the server 1 may have the structure of the recording device 10, and an accessible range in the secure areas of the server 1 may be changed according to a boot state of the electronic terminal 30 when the electronic terminal 30 is connected to the server 1.

If the electronic terminal 30 corresponds to a network boot, the present invention can be realized easily.

The following simply describes a specific operation of the recording device.

FIG. 20 is a flowchart showing processing performed when the electronic terminal 30 corresponding to the network boot is booted. Note that the processing shown in FIG. 20 is substantially same as the processing shown in FIG. 8. In this modification, the electronic terminal 30 performs processing in a step S11-1 instead of the processing in the step S11 in FIG. 8.

The following describes a detail of the processing in the step S11-1. When the BIOS 43 is loaded in the memory of the electronic terminal 30 and executed in the step S9, the BIOS 43 judges whether or not the network boot is executed (S11-1). More specifically, the BIOS 43 searches a server corresponding to the network boot, and executes the network boot when the BIOS 43 succeeds in the search (“YES” in S11-1). On the other hand, when the BIOS 43 fails to search the server, the BIOS 43 does not execute the network boot and the boot is executed by the boot loader of the electronic terminal 30 (“NO” in S11-1). The examples of the case in which the BIOS 43 fails to search the server are such as a case in which the electronic terminal 30 is not connected to the network though the BIOS 43 searches a server corresponding to the network boot, or a case in which even if the electronic terminal 30 is connected to the network, the BIOS 43 cannot find the server corresponding to the network boot.

When the BIOS 43 succeeds in searching the server corresponding to the network boot (“YES” in S11-1), the BIOS 43 is connected to the server, and performs processing (S40-1) when the electronic terminal 30 is connected to the server as shown in FIG. 20. Since processing other than the steps S11-1 and S40-1 are same as in the FIG. 8, the same reference marks are assigned to the steps and the explanation thereof will be omitted.

The following describes processing performed when the electronic terminal 30 detects the server corresponding to the network boot in a state in which the boot loader 44 of the electronic terminal 30 has been activated, with reference to FIG. 21. Note that the server 1 corresponds to the network boot and has a same structure as the recording media 10 in FIG. 21. Also, the server 1 is connected to the electronic terminal 30 via the network 2. Here, the network 2 may be a wired connection or a wireless connection, and a size of the communication network is not limited, and may be a LAN, MAN (Metropolitan Area Network), or a WAN (Wide Area Network).

As shown in FIG. 21, when detecting the server 1 by connecting to the network 2 (S37-1), the electronic terminal 30 is connected to the server 1 via the network 2, and performs the processing when the electronic terminal 30 is connected to the server 1 (S40-1).

Although the following describes the processing in the step S40-1 in detail, with reference to FIG. 22, this processing is substantially same as the processing in the explanation of “4.4. Detail of processing when the recording media 10 is inserted in the electronic terminal 30” in which the recording media 10 is replaced with the server 1. The following is a difference between the above embodiment and this modification. In the above embodiment, (i) processing of judging a boot state of the electronic terminal 30 when the recording media 10 is inserted therein is performed. On the other hand, in this modification, processing of judging a boot state of the electronic terminal 30 when the electronic terminal 30 is connected to the server 1 is performed.

The following describes a detail of the processing in the step S40-1.

FIGS. 22 and 23 are flowcharts showing processing performed when the electronic terminal 30 is connected to a server corresponding to the network boot.

When connected to the server 1, the electronic terminal 30 requests the server 1 to transmit the terminal control program 26. The electronic terminal 30 receives the terminal control program 26 transmitted from the server 1 in response to the request, and loads the received terminal control program 26 in a memory to realize the terminal side control unit 35 (S41-1).

Then, the terminal side control unit 35 of the electronic terminal 30 and the server 1 perform processing of judging the boot state of the electronic terminal 30 (S43-1 and S45-1). The following specifically describes the processing in the steps S43-1 and S45-1. FIG. 24 is a flowchart showing an operation of the electronic terminal 30 and judgment processing of a boot state of the electronic terminal 30 performed by the server 1.

The terminal side control unit 35 of the electronic terminal 30 outputs a value of at least one PCR corresponding to each program that is activated when the boot processing of the electronic terminal 30 is performed, to the server 1 via the network 2 (S67-1). A difference between the step S67 in FIG. 13 and the step S67-1 is an output destination of the value of the PCR. In other words, the value of the PCR is outputted to the recording media 10 in the step S67, and the value of the PCR is outputted to the server 1 in the step S67-1.

When the value of the predetermined PCR is outputted to the server 1 from the electronic terminal 30 in the step S67-1, the server 1 performs the same processing as in the step S69 in FIG. 13 and in FIG. 14 to judge the boot state of the electronic terminal 30 (S69). In the steps S43-1 and S45-1, a judgment result of the boot state is stored in the boot procedure recording unit 13 of the server 1 as a boot state flag.

Back to FIG. 22, when the processing in the steps S43-1 and S45-1 are completed, the terminal side control unit 35 performs the same processing as in the step S47 in FIG. 11. This processing is same as the processing described with reference to FIGS. 15 to 17 in which the recording media 10 is replaced with the server 1. Therefore, the detailed explanation thereof will be omitted.

When the second basic software 46 is activated (S35), the terminal side control unit 35 outputs a value of the PCR (PCR4) corresponding to the second basic software 46, to the server 1 via the network 2 as an authentication code (S49-1). A difference between the step S49 and the step S49-1 is an output destination of the authentication code. In other words, the authentication code is outputted to the recording media 10 in the step S49, and the authentication code is outputted to the server 1 in the step S49-1.

The explanation is continued with reference to FIG. 23.

When receiving the authentication code from the electronic terminal 30, the server 1 performs the same processing as the processing described in the steps S51, S53, and S55 in FIG. 12. Although the recording media 10 performs the processing in the steps S51, S53, and S55 in FIG. 12, the server 1 performs the processing in this modification.

When the electronic terminal 30 is judged to be valid in the processing in the steps S51 and S53, the terminal judgment unit 16 of the server 1 specifies a terminal authentication program. Therefore, the execution unit 15 of the server 1 outputs the specified terminal authentication program to the electronic terminal 30 via the network 2 (S57-1).

Since the subsequent processing performed by the electronic terminal 30 and the server 1 is same as the processing in the steps S59, S61, S63, and S65 in FIG. 12 in which the recording media 10 is replaced with the server 1. Therefore, the detailed explanation thereof will be omitted.

As mentioned above, the present invention can be applied to the recording device corresponding to the network boot.

### (11) Judging Method of Boot State

In the above embodiment, the terminal control program 26 calculates a hash value using a HMAC operation in which a key included in the terminal control program 26 (a key specific to the recording media 10) is used. If the recording media 10 is inserted in the electronic terminal 30 when the electronic terminal 30 is “at the beginning of a boot” or “in the middle of a boot”, the terminal control program 26 calculates a hash value of the second basic software 46 using the HMAC operation. In the HMAC operation, a result changes according to a used key and an operation target. Therefore, even if the HMAC operation using a same key (a key specific to the recording media 10 in this modification) is performed on a value of a PCR, a value of the PCR4 that is finally obtained is completely different between the case in which the HMAC operation is used in the authentication of the first basic software 45 (“at the beginning of a boot”) and the case in which the HMAC operation is used in the authentication of the second basic software 46 (“in the middle of a boot”). Because the HMAC operation by the terminal control program is not performed on a value of the PCR4 in the case of “after the completion of a boot”, this value is also different from a value obtained in the case of other boot states. Therefore, a value of the PCR4 is different according to a point of time when the recording media 10 is inserted in the electronic terminal 30, i.e. according to each of the states “at the beginning of a boot”, “in the middle of a boot”, and “after the completion of a boot”.

The following describes the above explanation, with reference to FIG. 25. FIG. 25 shows a value of the PCR4 in the case of “at the beginning of a boot”. FIG. 26 shows a value of the PCR4 in the case of “in the middle of a boot”. FIG. 27 shows a value of the PCR4 in the case of “after the completion of a boot”. In the explanation of the step S93 in the above embodiment, in the case of “at the beginning of a boot”, the SM 34 performs the processing of extending the value of the PCR using the operation PCR2=SHA-1 (PCR1+In (BL)) in which a hash value of the terminal control program 26 is defined as In (BL). However, a hash value of the terminal control program 26 calculated using the HMAC operation is defined as In (BL_HMAC) for convenience, in order to indicate that the hash value is calculated using the HMAC operation in FIG. 25. In the same manner as this, a hash value of the first basic software 45 calculated by the terminal control program 26 using the HMAC operation is defined as In (OS1_HMAC). Also, a hash value of the second basic software 46 calculated using the HMAC operation is defined as In (OS2_HMAC) in FIG. 26.

When FIGS. 25, 26, and 27 are compared with each other, it turns out that a value of the PCR4 is different according to a boot state. For example, a value of the PCR3 in the case of “at the beginning of a boot” is different from a value of the PCR3 in each of the cases of “in the middle of a boot” and “after the completion of a boot”. Therefore, a value of the PCR4 that is calculated using the value of the PCR3 in the case of “at the beginning of a boot” is different from a value of the PCR4 in each of the cases of “in the middle of a boot” and “after the completion of a boot”. Also, when “in the middle of a boot” is compared with “after the completion of a boot”, it turns out that a value of the PCR4 is different.

Therefore, the boot state of the electronic terminal 30 can be judged by which authentication code that has been held is identical to the value of the PCR4 in the step S51, instead of the step S69 in which the boot state of the electronic terminal 30 can be judged by whether or not the predetermined PCR has a value.

The value of the PCR4 does not vary and reflects the boot state even if the recording media 10 is removed from the electronic terminal 30 after the operation is performed on the value. Therefore, if the recording media 10 is inserted in the electronic terminal 30 and processing when the recording media 10 is inserted in the electronic terminal 30 is performed once, the boot state of the electronic terminal 30 when the recording media 10 is inserted in the electronic terminal 30 for the first time can be judged by comparing a value of a predetermined PCR (PCR4) that is used for confirmation of the validity with an authentication code of the terminal judgment unit 16 in the SM 34, even if the recording media 10 is removed from the electronic terminal 30 and then the recording media 10 is inserted in the electronic terminal 30 again. In other words, the electronic terminal 30 can access data in the secure areas of the recording media 10, even if the recording media 10 is inserted in the electronic terminal 30 again, with same security as before the recording media 10 is removed from the electronic terminal 30.

The above processing can be realized by performing the processing shown in FIG. 28 by the recording media 10, instead of the step S69, in FIG. 13, i.e. the processing that has been specifically described in FIG. 14. FIG. 28 is a flowchart showing a detail of the judgment processing of the boot state. Note that the recording media 10 has held values each of which is a value of the PCR4 corresponding to each boot state as shown in FIGS. 25, 26, and 27 in the terminal judgment unit 16 as authentication codes. Then, the recording media 10 compares the value of the PCR4 obtained from the electronic terminal 30 in the step S73 with the held authentication codes.

A difference between the processing in FIG. 14 and the processing in FIG. 28 is that when the PCR4 is judged to have a value in the step S75 (“YES” in S75), the terminal state judgment unit 12 compares the value of the PCR4 with the authentication codes (S80), and the terminal state judgment unit 12 sets a value to the boot state flag according to the identical authentication code (S82). For example, when the value of the PCR4 obtained in the step S73 is identical to the value of the PCR4 shown in FIG. 25, the result indicates that the boot state of the electronic terminal 30 is judged to be “at the beginning of a boot” when the recording media 10 is inserted in the electronic terminal 30 for the first time. Therefore, the terminal state judgment unit 12 sets the boot state flag to indicate “at the beginning of a boot”. In the same manner as this, when the value of the PCR4 obtained in the step S73 is identical to the value of the PCR4 shown in FIG. 26, the terminal state judgment unit 12 sets the boot state flag to indicate “in the middle of a boot” in the step S82. Also, when the value of the PCR4 obtained in the step S73 is identical to the value of the PCR4 shown in FIG. 27, the terminal state judgment unit 12 sets the boot state flag to indicate “after the completion of a boot” in the step S82.

In the above explanation, firstly, it is judged whether or not the PCR4 has a value, i.e. whether or not a value of the PCR4 is identical to “0” (S75), and then the processing in the step S80 is performed. However, it is not required to firstly judge whether or not the value of the PCR4 is identical to “0”. The terminal state judgment unit 12 may compare the value of the PCR4 with the authentication codes and “0” (i.e. when the PCR4 does not have a value), and the processing in the step S77 may be performed when the value of the PCR4 is identical to “0”.

Note that the processing in the step S80 is substantially combined with the processing in the steps S51 and S53. When the value of the PCR4 is not identical to the authentication codes held by the terminal judgment unit 16 for judging the boot state in the step S80, the terminal state judgment unit 12 judges that the electronic terminal 30 is not valid, and the processing in the step S55 is performed.

Although the boot state of the electronic terminal 30 is judged based on the value of the PCR4, the boot state may be judged based on a value of other PCR. For example, each value of the PCR2 and the PCR3 in the case of “at the beginning of a boot” is different from other states. Therefore, whether or not the state is “at the beginning of a boot” may be judged based on the value of each of the PCR2 and the PCR3. In detail, the boot state may be judged according to whether or not the value of the PCR is identical to the predetermined values shown in FIGS. 25 to 27, if using a value of the PCR that is different according to the boot state.

Note that the key used for the HMAC operation is not limited to the key specific to the recording media 10, and may be a key that is different for each terminal control program. In this case, the same result can be obtained.

In the above explanation, it has been described that each component is in one-to-one correspondence with a PCR, with reference to FIG. 15 and the like. However, it is not necessarily required to have the relation of the one-to-one correspondence. For example, the extension processing of the PCR may be performed using one PCR. In this case, the boot state can be judged. For instance, when a value of the PCR when the recording media 10 is inserted in the electronic terminal 30 is identical to SHA-1 (In (BIOS)), the boot state may be judged to be “at the beginning of a boot” from FIG. 25. This is because of the following reason. If the recording media 10 is inserted in the electronic terminal 30 when the boot state of the electronic terminal 30 is “in the middle of a boot” or “after the completion of a boot”, the value of the PCR is supposed to be identical to a value indicated as the PCR3 in FIG. 26 or a value indicated as the PCR4 in FIG. 27. In other words, a value of a certain PCR that is supposed to be indicated in each boot state may be compared with the value of the certain PCR that is outputted from the electronic terminal 30 when the recording media 10 is inserted in the electronic terminal 30. In the above embodiment, the electronic terminal 30 outputs the value of the certain PCR to the recording media 10 in the step S67. A detail of a subsequent processing in the step S69, i.e. a detail of the judgment processing of the boot state performed by the recording media 10 will be described as a flowchart in FIG. 29. When receiving the value of the certain PCR from the electronic terminal 30 (S73-1), the terminal state judgment unit 12 compares the value of the certain PCR with the value of the PCR1 in FIG. 25, the value of the PCR3 in FIG. 26, and the value of the PCR4 in FIG. 27 to judge whether or not the value of the certain PCR is identical to any of those values (S80-1). The terminal state judgment unit 12 sets a value to the boot state flag according to the identical value (S82-1). As mentioned above, the boot state can be judged when the extension processing is performed by the certain PCR.

Also, when the electronic terminal 30 conforms to the specification of the TCG as mentioned above, the electronic terminal 30 generates a SML (Stored Measurement Log). Therefore, the terminal state judgment unit 12 can judge the boot state based on the SML.

### (12) Other

In view of a risk that the authentication codes are stolen from the SM 34, when the recording media 10 is removed from the electronic terminal 30, the electronic terminal 30 may delete the authentication codes in the SM 34.

In this case, a predetermined PCR (PCR4) of the SM 34 that is used for judging the boot state has any value. As a result, the electronic terminal 30 is judged to be “after the completion of a boot” in the judgment performed by the terminal state judgment unit 12.

In detail, if the recording media 10 is removed from the electronic terminal 30 once, after that, the electronic terminal 30 can access only an area that is accessible when the electronic terminal 30 is “after the completion of a boot” regardless of an accessible secure area before the recording media 10 is removed from the electronic terminal 30. Or if the recording media 10 is removed from the electronic terminal 30 once, the electronic terminal 30 can access only a predetermined area in the secure areas (such as the general area).

### <Supplement>

Up to now, the recording media and the electronic terminal of the present invention have been described specifically through the above-mentioned embodiment. However, the technical scope of the present invention is not limited to the above-mentioned embodiment. For example, the following are modifications.

(1) More specifically, each of the above devices is a computer system that is composed of a microprocessor, a ROM, a RAM, a hard disk unit, a display unit, a keyboard, a mouse, and the like. A computer program is stored in the RAM or the hard disk unit. Each of the above devices fulfills a function thereof by the microprocessor operating in accordance with the computer program. Here, the computer program is composed of a plurality of combined instruction codes indicating an instruction to a computer in order to fulfill a predetermined function. Note that each of the above devices is not limited to the computer system that is composed of all of the microprocessor, the ROM, the RAM, the hard disk unit, the display unit, the keyboard, the mouse, and the like, and may be a computer system that is composed of a part of these component parts.
(2) A part or all of the component parts that construct each device of the present invention may be constructed by one system LSI (Large Scale Integration). The system LSI is a highly functional LSI that is manufactured by accumulating a plurality of component parts on one chip. More specifically, the system LSI is a computer system including a microprocessor, a ROM, a RAM, or the like. A computer program is stored in the RAM. Because the microprocessor operates in accordance with the computer program, the system LSI achieves a function thereof.

Although it is mentioned as the system LSI here, it is also referred to as an IC, LSI, super LSI, or ultra LSI, in accordance with an integration degree. Also, a method of circuit integration is not limited to LSI, and can be realized by a dedicated circuit or a general-purpose processor. A FPGA (Field Programmable Gate Array) which is programmable after manufacturing LSI, and a reconfigurable processor which can reconfigure a connection and a setting of a circuit cell in LSI may be used.

Moreover, if a technology of circuit integration which replaces LSI comes along because of progress of a semiconductor technology or other technologies which derive from the semiconductor technology, integration of a functional block may rightly be performed using the technology. An application of a biotechnology may be regarded as the possibility.

(3) A part or all of the component parts that construct each device of the present invention may be constructed by an IC card which is removable from each device or a single module. The IC card or the module is a computer system which is constructed by a microprocessor, a ROM, a RAM, or the like. The IC card or the module may include the highly functional LSI. Because the microprocessor operates in accordance with the computer program, the IC card or the module achieves a function thereof. The IC card or the module may have a tamper resistant.
(4) The present invention may be realized by methods described in the above-mentioned embodiment. Also, the present invention may be realized by a computer program executed on a computer for realizing these methods, or by a digital signal representing the computer program.

Also, the present invention may be realized by a computer-readable recording medium on which the computer program or the digital signal is recorded. Examples of the computer-readable recording medium include a flexible disk, a hard disk, a CD-ROM, an MO, a DVD, a DVD-ROM, a DVD-RAM, BD (Blu-ray Disc), and a semiconductor memory. Also, the present invention may be realized by the computer program or the digital signal recorded on such recording media.

Further, the present invention may be realized by the computer program or the digital signal transmitted via an electric communication line, a wired/wireless communication line, a network such as the Internet, or data broadcast.

Moreover, the present invention may be realized by a computer system including a microprocessor and a memory. The memory may store the computer program, and the microprocessor may operate in accordance with the computer program.

The computer program or the digital signal may be transferred as being recorded on the recording medium, or via the network or the like, so that the computer program or the digital signal may be executed by another independent computer system.

(5) The above-mentioned embodiment and the modifications can be freely combined.
(6) When the recording device and the electronic terminal of the present invention are used, data used for work in, for example, a place in which data is routinely dealt with (such as an office) is recorded in the recording device. When leaving the office, a user takes only the recording device to an outside location. At the outside location, authentication processing is performed on an electronic terminal in the outside location according to a security level of data which the user would like to access in order to realize a restriction of access to confidential data. Therefore, it is extremely useful when accessing data that does not require a high security level at a high speed.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be constructed as being included therein.

What is claimed is:

1. A recording device that is connectable to an electronic terminal, comprising:
a secure area for storing data therein;
a terminal state judgment unit operable to, upon connection of the recording device with the electronic terminal, judge activation completion states of a plurality of components of the electronic terminal, the plurality of components being activated in stages when the electronic terminal is booted; and
an access control unit operable to restrict an accessible range of the secure area from the electronic terminal, according to a result of the judgment by the terminal state judgment unit.

2. The recording device of claim 1, wherein
the electronic terminal sequentially updates configuration information indicating a configuration of the electronic terminal, in response to activation of each of the plurality of components, and
the terminal state judgment unit obtains the configuration information upon the connection of the recording device with the electronic terminal and performs the judgment based on the obtained configuration information.

3. The recording device of claim 2, wherein
the recording device stores therein a terminal control program including a code for controlling the electronic terminal,
the terminal control program is read and executed by the electronic terminal upon the connection of the recording device with the electronic terminal,
the terminal control program includes an output step of causing the electronic terminal to output the configuration information to the recording device, and
the terminal state judgment unit receives, after the terminal control program is executed by the electronic terminal, the configuration information outputted in the output step and performs the judgment based on the received configuration information.

4. The recording device of claim 2, wherein
the recording device stores therein a terminal control program including a code for controlling the electronic terminal,
the terminal control program includes specific information, and is read and executed by the electronic terminal upon the connection of the recording device with the electronic terminal,
the electronic terminal updates the configuration information every time any of the plurality of components is activated,
the terminal control program includes an updating step of causing the electronic terminal to update the configuration information every time any unactivated component of the plurality of components is activated, and
in the updating step, the electronic terminal updates the configuration information by processing using information about the unactivated component and the specific information.

5. The recording device of claim 4, wherein
the recording device holds, as comparative information, a value to be indicated by the configuration information upon completion of activation of all of the plurality of components,
the comparative information includes a plurality of values to be indicated by the configuration information that are determined according to which one of the plurality of components is a target of the updating, and
the terminal state judgment unit performs the judgment by comparing a value of the obtained configuration information with the plurality of values to be indicated by the configuration information to see which one of the plurality of values is identical to the value of the obtained configuration information.

6. The recording device of claim 2, wherein
the electronic terminal performs the updating by initializing the configuration information when the electronic terminal is booted or reset, and adding a value to the configuration information in stages in response to the activation of each of the plurality of components, and
the terminal state judgment unit performs the judgment based on whether or not the value is added to the configuration information.

7. The recording device of claim 2, wherein
the electronic terminal updates the configuration information in stages in response to the activation of each of the plurality of components, and
the terminal state judgment unit performs the judgment by comparing a value to be indicated by the configuration information in each of the stages with a value of the obtained configuration information to see which value is identical to the value of the obtained configuration information.

8. The recording device of claim 1, wherein
the secure area is accessible only when the judgment is performed by the terminal state judgment unit,
the electronic terminal includes:
an input-output interface that detects whether or not the recording device is connected to the electronic terminal; and
a receiving unit operable to, when the detection is performed by the input-output interface, receive a user input requesting to (i) perform first boot processing including the judgment by the terminal state judgment unit or (ii) perform second boot processing excluding the judgment,
when the receiving unit receives the user input requesting to perform the first boot processing, the electronic terminal performs processing for the judgment by the terminal state judgment unit, and
when the receiving unit receives the user input requesting to perform the second boot processing, the electronic terminal prohibits the processing for the judgment by the terminal state judgment unit.

9. The recording device of claim 6, wherein
the electronic terminal includes a Trusted Platform Module specified by a Trusted Computing Group,
a hash value of each of the plurality of components is transmitted to the Trusted Platform Module in response to the activation of the component,
the Trusted Platform Module includes a plurality of PCRs and performs processing of extending a value of each of the plurality of PCRs using the transmitted hash value to store the extended value in the PCR,
the configuration information is the extended value stored in the PCR, and
the terminal state judgment unit performs the judgment according to whether or not a value other than an initial value is stored in a predetermined PCR of the plurality of PCRs upon the connection of the recording device with the electronic terminal.

10. The recording device of claim 7, wherein
the electronic terminal includes a Trusted Platform Module specified by a Trusted Computing Group,
a hash value of each of the plurality of components is transmitted to the Trusted Platform Module in response to the activation of the component,
the Trusted Platform Module includes a PCR and performs processing of extending a value of the PCR using the transmitted hash value to store the extended value in the PCR,
the configuration information is the extended value stored in the PCR, and
the terminal state judgment unit performs the judgment by comparing a value to be stored in the PCR in each of the stages with a value of the PCR upon the connection of the recording device with the electronic terminal to see which value is identical to the value of the PCR.

11. A recording device that is connectable to an electronic terminal, comprising:
a secure area for storing data therein;
an obtaining unit operable to, upon connection of the recording device with the electronic terminal, obtain activation state information indicating which one of a plurality of activation states corresponds to activation completion states of a plurality of components of the electronic terminal, the plurality of components being activated in stages when the electronic terminal is booted; and
an access control unit operable to restrict an accessible range of the secure area from the electronic terminal, according to the activation state indicated by the obtained activation state information.

12. An integrated circuit used for a recording device that is connectable to an electronic terminal and comprises a secure area for storing data therein, the integrated circuit including:
a terminal state judgment unit operable to, upon connection of the recording device with the electronic terminal, judge activation completion states of a plurality of components of the electronic terminal, the plurality of components being activated in stages when the electronic terminal is booted; and
an access control unit operable to restrict an accessible range of the secure area from the electronic terminal, according to a result of the judgment by the terminal state judgment unit.

13. An access restriction method of restricting access from an electronic terminal to a recording device that is connectable to the electronic terminal and comprises a secure area for storing data therein, the access restriction method including:
a terminal state judgment step of, upon connection of the recording device with the electronic terminal, judging activation completion states of a plurality of components of the electronic terminal, the plurality of components being activated in stages when the electronic terminal is booted; and
an access control step of restricting an accessible range of the secure area from the electronic terminal, according to a result of the judgment by the terminal state judgment step.

14. A program recording medium that records therein a computer readable control program for causing a recording device to perform processing of restricting access from an electronic terminal to the recording device that is connectable to the electronic terminal and comprises a secure area for storing data therein, wherein
the control program includes:
a terminal state judgment step of, upon connection of the recording device with the electronic terminal, causing the recording device to perform processing of judging activation completion states of a plurality of components of the electronic terminal, the plurality of components being activated in stages when the electronic terminal is booted; and
an access control step of causing the recording device to perform processing of restricting an accessible range of the secure area from the electronic terminal, according to a result of the judgment by the terminal state judgment step.
